(19) United States
(12) Patent Application Publication
(10) Pub. No.: US 2024/0173678 A1
(43) Pub. Date: May 30, 2024

(54) High Performance Double Layer Ion Selective Membrane With Nanoporous Boron Nitride And Polyetherimide

(71) Applicant: Northeastern University, Boston, MA (US)

(72) Inventor: Hongli Zhu, Newton, MA (US)

(21) Appl. No.: 18/521,460

(22) Filed: Nov. 28, 2023

Related U.S. Application Data
(60) Provisional application No. 63/385,199, filed on Nov. 28, 2022.

(51) Int. Cl. B01D 69/12; B01D 67/00; B01D 71/02; B01D 71/64

(52) U.S. Cl. CPC B01D 69/12; B01D 67/0009; B01D 71/02; B01D 71/643; B01D 2325/04; B01D 2325/42

(57) ABSTRACT

Disclosed herein is a double-layer ion-selective membrane, method of production, applications of the double-layer ion-selective membrane as a redox flow cell, a fuel cell, and used for wastewater and air purification. The double-layer ion-selective membrane is comprised of a polyetherimide (PEI) layer and an ultrathin layer comprising porous boron nitride (PBN) flakes enmeshed by a NAFION™ resin. The double layer membrane exhibits ion-selectivity and ion-conductivity enabling the membrane to be used in a redox flow cell battery, a fuel cell battery, and to be used in wastewater and air purification applications.

### RELATED APPLICATIONS

This application claims the benefit of U.S. Provisional Application No. 63/385,199, filed on Nov. 28, 2022. The entire teachings of the above application are incorporated herein by reference.

### BACKGROUND

Flow batteries have attracted great attention as a large-scale energy storage technology because of their unique feature of uncoupling power and energy, which allows the expansion of energy storage by increasing the volume or concentration of the electrolyte. Compared with other electrochemical technologies, such as lead-acid, lithium-ion, and sodium-based batteries, flow batteries have the merits of long life, high safety, and low cost. The ion-selective membrane is an important part of flow batteries because it allows specific ions to pass through to maintain neutral charge in the cell and prevents the crossover of active species to maintain the capacity. The properties of the ion selective membrane significantly determine the performance of the flow battery. Ideal ion-selective membranes should have high ion conductivity and selectivity, high chemical stability, good mechanical strength, and low cost.

Based on the ion-selective mechanisms, ion-selective membranes can be classified into ion-exchange and porous membranes. The ion-exchange membranes contain anion (cation exchange membranes) or cation (anion exchange membranes) groups, which provide ion conductivity and selectivity based on the Donnan exclusion mechanism.

NAFION™ membranes are typical cation exchange membranes that are widely used in flow batteries (NAFION™ is a trademark of The Chemours Company FC, LLC). NAFION™ membranes have polytetrafluoroethylene main chains and side chains with superacidic sulfonic acid groups. Hydrophilic sulfonic acid groups constitute ion-transmission channels that provide excellent cation conductivity. However, the heavy crossover issue owing to the large amount of cation active species and extremely high cost hinders the promotion of NAFION™ membranes.

Sulfonated poly(ether ether ketone) (SPEEK) is an attractive ion exchange membrane with relatively low cost and high stability. Compared with NAFION™, SPEEK has higher ion selectivity owing to the less acidic sulfonic acid groups and hydrophobic PEEK backbone; however the ion conductive channels are relatively tortuous. To achieve sufficient ion conductivity, a high sulfonation degree of SPEEK is needed, which may cause heavy swelling, decrease stability, and reduce ion selectivity.

Porous membranes prepared by the non-solvent induced phase separation (NIPS) method have been adopted as ion selective membranes in flow batteries in the last decade because of their low cost and high ion conductivity. The ion selectivity is mainly based on the pore size exclusion mechanism. These membranes exhibit asymmetric finger-like pores in the vertical direction and thin skin layers on the top and bottom surfaces. The vertical finger-like pores provide excellent ion conductivity, and the ion selectivity is mainly ascribed to the pore morphology in the skin layer. In particular, a dense and thick skin layer should be formed to achieve high ion selectivity; however, this approach also decreases the size and density of the vertical pores, which is detrimental to the ion conductivity of the membrane.

Traditional ion-exchange and porous membranes are based on a single-ion selective mechanism that requires a tradeoff between ion selectivity and conductivity.

### SUMMARY

Disclosed herein is a double-layer ion-selective membrane, method of production, applications of the double-layer ion-selective membrane as a redox flow cell, a fuel cell, and used for wastewater and air purification. The double-layer ion-selective membrane is comprised of a polyetherimide (PEI) layer and an ultrathin layer comprising porous boron nitride (PBN) flakes enmeshed by a perfluorinated sulfonic acid ionomer resin (NAFION™ resin). The double layer membrane exhibits ion-selectivity and ion-conductivity enabling the membrane to be used in a redox flow cell battery, a fuel cell battery, and to be used in wastewater and air purification applications.

Overall, the double-layer design with a low-cost PEI supporting layer and ultrathin (μm) PBN ion-selective layer significantly reduced the cost compared with the NAFION™ 115 membrane, which is beneficial to the commercialization and promotion of PBN-PEI membranes.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing will be apparent from the following more particular description of example embodiments, including those illustrated in the drawings. The drawings are not necessarily to scale, emphasis instead being placed upon illustrating embodiments.

FIGS. 1A-1D are schematics. FIG. 1A is a schematic of the two-layer PBN-PEI membrane in Vanadium Redox Flow Battery (VRFB). The blue and white layers represent the PEI highly ion-conductive and PBN bifunctional ion-selective layers, respectively. FIG. 1B is a schematic of the PEI highly ion-conductive supporting layer. FIG. 1C is a schematic of the PBN ion-selective layer. FIG. 1D is a schematic of the proton conduction mechanisms in the PBN layer.

FIGS. 2A-2L are SEM images. FIG. 2A is an image the top surface and FIG. 2B is the cross-section of the PEI membrane. FIG. 2C is the XCT 3D reconstruction of the PEI membrane (the top surface was removed). FIGS. 2D-2F are SEM images of pristine PBN. FIG. 2G is the XRD spectrum of pristine PBN, PBN after treatment, and BN (hp4) (PDF #45-0894). FIG. 2H is the FTIR spectrum of PBN before and after treatment. FIG. 2I is the TGA of pristine PBN, PBN after treatment, and commercial hBN. FIG. 2J is Nitrogen adsorption-desorption isotherms, FIG. 2K is Pore size distributions by the NLDFT method, and FIG. 2L is Cumulative pore volume of PBN after treatment.

FIGS. 3A-3I are schematics. FIG. 3A is a schematic of the PBN layer with different PBN ratio. FIGS. 3B-3E are SEM images of the cross-sections of FIG. 3B NAFION™-PEI (0% PBN-PEI), FIG. 3C 25% PBN-PEI, FIG. 3D 50% PBN-PEI, and FIG. 3E 75% PBN-PEI membranes. FIGS. 3F-3I are SEM images of the top surfaces of FIG. 3F 0% PBN-PEI (NAFION™-PEI), FIG. 3G 25% PBN-PEI, FIG. 3H 50% PBN-PEI, and FIG. 3I 75% PBN-PEI membranes.

FIGS. 4A-4F. FIG. 4A are Contact angles of NAFION™ and various PBN layers. FIG. 4B is the Water uptake and swelling ratio of the pristine PEI, various PBN-PEI, NAFION™-PEI, and NAFION™ 115 membranes. FIG. 4C is the Stress-strain curves of the pristine PEI, various PBN-PEI membranes, and NAFION™-PEI membrane. FIG. 4D is the area resistance and ion conductivity, FIG. 3E is the time-dependent vanadium ion concentration, and FIG. 4F is the vanadium (IV) permeabilities and ion selectivity of the pristine PEI, various PBN-PEI, NAFION™-PEI, and NAFION™ 115 membranes.

FIGS. 5A-5F are Performance of VRFB assembled by PEI, 50% PBN-PEI, and commercial NAFION™ 115 membranes. FIG. 5A is the current rate performance of the PEI, 50% PBN-PEI, NAFION™ 115, and NAFION™-PEI membranes at current densities of 40, 60, 80, 100, 120, 160, and 200 mA cm⁻². Comparison of FIG. 4B Coulombic efficiency, FIG. 5C voltage efficiency, and FIG. 4D energy efficiency of 50% PBN-PEI and NAFION™ 115 membranes at different current densities. FIG. 5E is the Charge-discharge profiles of 50% PBN-PEI membrane at different current densities. FIG. 5F is a comparison of the charge-discharge profiles of PEI, 50% PBN-PEI, and NAFION™ 115 membranes at the current density of 40 mA cm⁻².

FIGS. 6A-6D. FIG. 6A shows the cycling stability in terms of the coulombic, voltage, and energy efficiencies; and discharge capacity of 50% PBN-PEI membrane at the current density of 100 mA cm⁻², compared to the discharge charge capacity of NAFION™ 115, NAFION™-PEI, and pristine PEI membranes. Post-mortem analysis of 50% PBN-PEI membrane before and after cycling in VRFB. FTIR spectra of the FIG. 6B PBN layer and FIG. 6C PEI layer before and after cycling. FIG. 6D Stress-strain curves of the 50% PBN-PEI membrane before and after cycling.

FIG. 7 is a digital picture of the porous PEI membrane in DI water.

FIG. 8 is the contact angle of the pristine PEI membrane.

FIG. 9 is an SEM image of the secondary pores on the pore walls of the PEI membrane.

FIGS. 10A-10B. FIG. 10A is the XRD spectrum and FIG. 10B is the FTIR spectrum of pristine PEI membrane and PEI membrane after stability test in 1M VOSO₄ and 3M H₂SO₄ solution.

FIGS. 11A-11C. FIG. 11A is a digital picture of the pristine PBN powder in a tablet format after applying pressure; Contact angle of FIG. 11B pristine PBN and FIG. 11C PBN after treatment. The morphology of the powders was changed after applying pressure, thus this measurement was only used to qualitatively compare the hydrophilicity of pristine PBN and PBN after treatment.

FIGS. 12A-12C. FIG. 12A is the Nitrogen adsorption-desorption isotherms, FIG. 12B Pore size distributions, and FIG. 12C is Cumulative pore volume of pristine PBN.

FIG. 13 is a digital picture of 50% PBN suspension in IPA.

FIG. 14 is a digital picture of the 50% PBN-PEI membrane after spray coating, the whiter square in the center is the coated area.

FIG. 15A-15L. (a-h) SEM images of the cross-section of the coating layer of the (a, e) NAFION™-PEI (0% PBN-PEI), (b, f) 25% PBN-PEI, (c, g) 50% PBN-PEI, and (d, h) 75% PBN-PEI membranes. (i-l) High magnification SEM images of the top surface of (i) NAFION™ (0% PBN), (j) 25% PBN, (k) 50% PBN, and (1) 75% PBN layers.

FIG. 16 is the FTIR spectrums of PBN composite with different weight ratios and the FTIR spectrums of PBN and NAFION™. PBN mainly has two characteristic peaks at 1403 cm⁻¹ (B—N stretching) and 808 cm⁻¹ (B—N—B stretching). NAFION™ exhibited four characteristic peaks at 976 cm⁻¹ (C—O—C stretching), 1060 cm⁻¹ (symmetric S—O stretching), 1145 cm⁻¹ (symmetric C—F stretching), and 1201 cm⁻¹ (asymmetric C—F stretching).

FIG. 17 is the stress-strain curve of NAFION™ 115 membrane.

FIG. 18 is the Nyquist plots of PEI, PBN-PEI, NAFION™-PEI, and NAFION™ 115 membranes.

FIG. 19 is the Ion conductivity of 25% PBN layer, 50% PBN layer, and 75% PBN layer.

FIG. 20 is the photography of the setup of the vanadium permeability. The left-side chamber was filled with 10 mL 1M VOSO₄ in a 3M H₂SO₄ solution, and the right-side chamber was filled with 10 mL 1M MgSO₄ in a 3M H₂SO₄ solution.

FIGS. 21A-21D are the Performance of VRFB assembled by 25% PBN-PEI and 75% PBN-PEI membranes. FIG. 21A Current rate performance at current densities of 40, 60, 80, 100, and 120 mA cm⁻². FIG. 21B Coulombic efficiency, FIG. 21C voltage efficiency, and FIG. 21D energy efficiency of 25% PBN-PEI and 75% PBN-PEI membranes at different current densities.

FIGS. 22A-22B are comparisons of the charge-discharge profiles of 50% PBN-PEI and NAFION™ 115 membranes at the current density of FIG. 22A 100 mA cm⁻² and FIG. 22B 200 mA cm⁻²

FIG. 23 is photography of vanadium redox flow battery at fully charge status.

### DETAILED DESCRIPTION

A description of example embodiments follows.

### Double-Layer Ion-Selective Membranes

In a first aspect, the application pertains to a double-layer ion-selective membrane, comprising or consisting of: a polyetherimide (PEI) layer having longitudinal unimpeded finger-like pores, and an ultrathin layer comprising porous boron nitride (PBN) flakes defining a tortuous path and enmeshed by a NAFION™ resin that forms proton transfer channels created by the sulfonic acid groups of the NAFION™ resin, the ultrathin layer coated on an open pore end of the PEI layer.

The double-layer ion-selective membrane of the disclosure is inspired by the features of different ion-selective membranes and porous boron nitride (PBN). The double-layer ion-selective membrane possesses a unique PBN bifunctional ion-selective layer and an ion-conductive porous polyetherimide (PEI) layer. The PEI layer is designed to provide a low-cost, yet highly functional conductive layer, while the PBN layer provides an ion selective layer at a low-cost while overcoming ion conductivity and selectivity issues compared to conventional ion-selective membranes.

The PEI layer serves a number of functional roles. It provides a supporting or mechanical layer for the ultrathin PBN layer, and is able to withstand strongly acidic environments, as is necessary for use in redox flow batteries, for example. As such, the thickness of the PEI supporting layer should be from about 10 μm to about 1000 μm, and in some embodiments from about 50 μm to about 200 μm, and yet in other embodiments from about 95 μm to about 105 μm. The thickness of the PEI layer also contributes to the functional properties of the double-layer ion-selective membrane.

Depending upon the intended use of the double-layer ion-selective membrane, the PEI layer can be designed with a thickness that is optimal for the intended use. In some embodiments, the ions conducted by the PEI layer may be protons and vanadium ions.

In other embodiments, such as in the air purification, the ions can be removed by the double layer membrane may be Hydrogen ions (H⁺), Hydronium ions (H₃O⁺), Hydroxide ions (OH⁻), Ammonium ions (NH₄⁺), Sodium ions (Na⁺), Chloride ions (Cl⁻), and Silver ions (Ag⁺). In the water purification, the ions can be removed by the double layer membrane can be calcium (Ca2+) and magnesium (Mg²⁺) ions, Chloride ions (Cl⁻), Nitrate (NO₃⁻) and sulfate (SO₄²⁻ions, Sodium (Na⁺) and potassium (K⁺) ions, Ammonium (NH₄⁺) ions, Heavy metal ions like copper (Cu²⁺), lead (Pb²⁺), chromium (Cr³⁺/Cr⁶⁺), Fluoride (F⁻) ions.

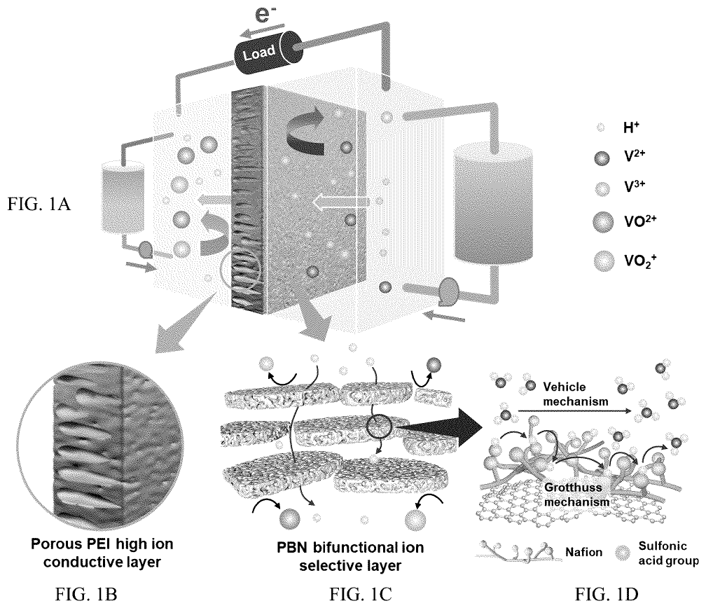

The PEI layer has unimpeding finger-like pores that extend across the thickness of the layer in the longitudinal plane, as illustrated in for example, FIG. 1B. The density of the pores can be varied depending upon the matter that the PEI layer is manufactured. The range of porosity is from about 30% to about 70% by volume. The range of pore size is about 500 nm to about 2 μm. From one side of the PEI layer (a first side) to the other side of the PEI layer (a second side), the longitudinal finger-like pores unimpedingly extend across the layer to provide a highly ion conductive layer. In some embodiments, a highly ion conductive layer is about 30 mS/cm. Ions are able to pass through the PEI layer moving from one side of the PEI layer to the other due to the conductive finger-like pores that extend from side to side of the membrane. The finger-like pores provide means for unhindered ion transfer, with ion selectivity attributable to the pore morphology in the surface layer. In some embodiments, the longitudinal unimpeded finger-like pores have secondary pore structures extending off the pore walls of the main finger-like pores. These secondary pores further enhance ion conductivity and provide a level of ion selectivity to the porous PEI membrane.

The porous boron nitride (PBN) is an ultrathin layer that is mechanically supported on the PEI layer. Nanoporous boron nitride (PBN) offers a high nanoporosity with superior chemical and thermal stability, high thermal conductivity, and excellent electrical insulating properties. The unique features of PBN provide excellent ion selectivity based on pore size exclusion mechanism and great stability in tough and high oxidation environments and prevent the short circuit in the battery.

An ultrathin layer for purposes of this disclosure should have a thickness of from about 2 μm to about 8 μm. In some embodiments, the PBN layer thickness is about 2 μm, about 3 μm, about 4 μm, about 5 μm, about 6 μm, about 7 μm, about 8 μm. In yet other embodiments the PBN layer thickness is from about 4 μm to about 5 μm. The ultrathin PBN layer is comprised of or consists of porous boron nitride (PBN) flakes that are assembled to create a tortuous path to selectively prevent or permit flow of ions, by size exclusion for example. The manner of assembly of the PBN flakes is shown in exemplary FIG. 1C, in a multilayer to achieve the desired thickness and tortuous path. In an embodiment, the PBN flakes are assembled in a tiling pattern (e.g., arrangement of similarly sized plane shapes in a layer so that they cover an area without overlapping). The PBN layer is a bifunctional ion selective layer meaning that the PBN layer enables ion conductivity and ion selectivity. Mixing of PBN with NAFION™ resin creates a nanoporous structure with ion-exchange groups. The ion-exchange groups transfer ions through the PBN flake layer, giving the PBN flakes their ion conductivity. The PBN flakes are rigid and thus suppress the movement of the polymer chains in the PBN layer and prevented the swelling of the membrane. The nanoporous structure of the PBN layer and their assembled configuration contribute to its ion selectivity properties. Not being bound to any one theory, pore size exclusion mechanism is the basis for the ion selectivity, as smaller ions will pass through the PBN layer while larger ions in size will not enter the PBN layer or become trapped in the pores of the PBN layer.

The PBN layer further comprises or consists of a NAFION™ resin enmeshed with the PBN flakes. The NAFION™ resin has a polytetrafluoroethylene main chains and side chains of super-acidic sulfonic acid groups. An exemplary artistic rendering of the enmeshed NAFION™ resin and PBN flakes is illustrated in FIG. 1D. As illustrated, the sulfonic acid groups of the NAFION™ resin extend outwardly from the PBN flake/NAFION™ resin layer to form proton transfer channels. Because the sulfonic acid groups are super-acidic sulfonic acid groups, they create high speed proton transfer channels on the surface of the PBN flake/NAFION™ resin layer. In some embodiments, a high-speed proton transfer channel is defined by an ion conductivity of about greater than 10 mS/cm. NAFION™ serves as a binder to keep the PBN and PEI layers bound together. When the NAFION™ resin is added to the PBN layer, the total thickness is within the ultrathin ranges as defined above for the PBN layer.

The ratio of PBN flakes to NAFION™ resin can vary depending upon the desired proprieties of the PBN layer, the degree of adherence to the PEI layer, and the degree of bonding of NAFION™ resin to the PBN flakes. In one embodiment, the ratio of PBN to NAFION™ resin is about 25: about 75, about 50: about 50, about 75: about 25 percent by weight. In another embodiment, the ratio of PBN flakes to NAFION™ resin is about 50: about 50 percent by weight. In embodiments, it is desirable to achieve a uniform coating of the PBN flakes and NAFION™ resin layer on the PEI support. This can be achieved by manipulating the ratio of PBN flakes and NAFION™ resin, and/or regulating the thickness of the PBN/NAFION™ layer on the PEI layer, depending upon the intended use of the PBN/NAFION™ layer. High amounts of NAFION™ resin may result in a clogged porous structure, while low amounts of NAFION™ can result in low ion conductivity.

Not being bound to any one theory, the mechanism for the PBN/NAFION™ layer for ion conductivity is based upon the combination of both a vehicle mechanism and the Grotthuss mechanism. The Grotthuss mechanism works by transporting protons through proton hopping, where a proton will move from a proton donor to a proton acceptor within a hydrogen bond network. The NAFION™ resin contains superacidic sulfonic acid (—SO₃H) groups which can act as both a proton donor and proton acceptor. Large amounts of these groups are found in NAFION™ and are at the surface when enmeshed with the PBN flakes, which facilitates the ion conductivity in part for the PBN/NAFION™ layer. The vehicle mechanism involves proton diffusion with the carrier to transport acidic media solvated ions and is dependent upon the concentration of ions present in the system. PBN and the surface sulfonic acid groups increase the water absorption by the membrane, enabling a better pathway for proton transfer through the vehicle mechanism. The existence of abundant ion-exchange groups, interconnectivity of the ionic clusters due to the extensive hydrogen bonding, and the acidity of the sulfonic acid groups enhances the proton conductivity.

In some embodiments, the PBN flakes/layer can be functionalized with proton donors and proton acceptors. In some embodiments, the PBN flakes/layer can be functionalized with hydroxyl and amino groups. Incorporation of these additional groups will facilitate proton transfer more rapidly by further interconnecting the hydrogen bonding network.

Together the thickness of the double-layer ion-selective membrane can be from about 12 μm to about 300000 μm, and in some embodiments from about 50 μm to about 500 μm, and yet in other embodiments from about 95 μm to about 115 μm. The thickness of the double-layer ion-selective membrane will ultimately be determined by the intended use. For example, as a membrane in a membrane flow battery, the desired thickness is from about 95 μm to about 115 μm. For use in a fuel cell, the desired thickness is from about 100 mm to about 300 mm. For use in wastewater treatment, the desired thickness is from about 100 μm to about 1000 μm.

### Methods of Making the Double-Layer Ion-Selective Membranes

In a second aspect, the disclosure pertains to methods of making the double-layer ion-selective membrane, as discussed above. The method comprises or consists of dispersing flakes of porous boron nitrate (PBN) and NAFION™ resin together in a solvent to produce a sprayable suspension of PBN flakes and NAFION™ resin; and spray coating the suspension of PBN flakes and NAFION™ resin in an amount sufficient to coat an ultrathin layer on an open pore side of a polyetherimide (PEI) membrane having longitudinal unimpeded finger-like pores, to produce a double-layer ion-selective membrane. The double-layer ion-selective membrane comprises: a polyetherimide (PEI) layer having longitudinal unimpeded finger-like pores, and an ultrathin layer comprising porous boron nitride (PBN) flakes defining a tortuous path and enmeshed by a NAFION™ resin that forms proton transfer channels created by the sulfonic acid groups of the NAFION™ resin, the ultrathin layer coated on an open pore end of the PEI layer.

A polyetherimide (PEI) membrane was prepared through a non-solvent induced phase separation (NIPS). The NIPS method is performed using a polymer, solvent, and a nonsolvent to fabricate membranes by controlling the interaction between the polymer and solvent(s) of interest. Membranes prepared by NIPS typically show a dense surface with an asymmetric morphology. Using this method enables the finger-like pores to be prepared in the PEI membrane, which may be attributed to improving the flow of protons and hence the high ion conductivity. The thickness of the PEI layer is dependent upon its intended use, for which the thickness is described above.

PBN was synthesized using a one-step template-free method and sonication in isopropanol. A porous boron nitride (PBN) layer was synthesized using boric acid, urea, and water, with further treatments of heating and grinding to prepare pristine PBN. In some embodiments, the PBN was further crystalized by suspending in isopropanol and sonicating. The PBN is combined with NAFION™ resin in uniform suspension, such that the NAFION™ sulfonic acid groups can interact with ions to facilitate ion transfer. The ratios of the PBN to NAFION™ are dependent upon the desired properties of the PBN layer, the degree of adherence to the PEI layer, and the degree of bonding of NAFION™ resin to the PBN flakes. Each of these attributes are described above in the membrane section. The PBN flake/NAFION™ resin suspension is sprayed on top of the PEI membrane using an airbrush until the surface becomes wet, and then treated with acid and heated. This treatment suppresses the movement of the polymer chains and prevents swelling of the membrane.

Compared with the most common ion selective membrane (NAFION™ 115 membrane) the PBN-PEI membrane of the disclosure exhibited lower area resistance (0.165 Ωcm² Vs 0.210 Ωcm²), lower vanadium permeability (4.27*10⁻⁷ cm²/min Vs 9.33*10⁻⁷ cm²/min), and high ion selectivity (14.89 10⁷ mS cm⁻³ min VS 6.48 10⁷ mS cm⁻³ min). Further, the double-layer design with a low-cost PEI supporting layer and ultrathin PBN ion-selective layer significantly reduced the cost compared with the NAFION™ 115 membrane, which is beneficial to the commercialization and promotion of PBN-PEI membranes.

### Fuel Cells

In another aspect, the double-layer ion-selective membranes of the disclosure can be used in fuel cells. The fuel cell of the disclosure comprises an anode, a cathode, a double-layer ion-selective member and an electrolyte between the anode and the cathode and incorporating fuel sources separately entering on the anode and cathode sides.

A fuel cell is an electrochemical cell that converts chemical energy of a fuel and an oxidizing agent into electricity through a pair of redox reactions. Fuel cells are different from most batteries in requiring a continuous source of fuel and oxygen to sustain the chemical reaction. In some embodiments, the PBN-PEI membrane as described in the membrane section may be used as a component of a proton-exchange membrane fuel cell (PEMFC) as the PBN-PEI membrane allows for the continuous flow of protons through the pores. An electrolyte, along with a cathode and anode will also comprise the PEMFC in order to have the proton exchange occur while using oxygen as an oxidizing agent and a form of chemical energy fuel to generate electricity. The anode will be connected to the membrane on one side with the cathode on the other side of the membrane, with both anode and cathode allowing for fuel flow and oxidant flow, respectively. The anode side has the fuel diffuse to the anode catalyst where it dissociates into protons and electrons. The protons will be conducted through the PBN-PEI membrane to the cathode, but the electrons will travel to an external circuit, which supplies power, as the membrane is electrically insulating. The cathode catalyst reacts oxygen molecules with the electrons and protons to form water. Though not bound to a single theory, this is possible due to the PBN-PEI membrane being hydrolytically stable.

### Wastewater Treatment/Air Purification

In yet another aspect, the double-layer ion-selective membranes of the disclosure can be used for wastewater treatment and air purification.

In an embodiment, the disclosure pertains to a wastewater purification system, such as a wastewater purification system, comprising the membranes described herein, wherein the membrane separates water from an aqueous solution through forward osmosis to recover water that is purified.

The PBN-PEI membrane as described herein can be used for wastewater treatment. This will be accomplished by connecting an anode and cathode to the PBN-PEI membrane and allowing wastewater to be chemically oxidized, removing organic and some inorganic impurities from the wastewater, and moving the oxidized byproducts into the PBN-PEI membrane. Removal of the impurities in the wastewater releases clean water from the cell. For water purification, the membrane thickness and porosity will be further tuned and adjusted based on the characteristics of water system.

In another embodiment, the disclosure pertains to an air purification system, comprising the membranes described herein, wherein the membrane separates polluted air by trapping impurities in the membrane and releasing purified air. This strategy can be further used for air purification, where the PBN-PEI membrane can capture particulates in the air while allowing air to pass through the membrane, removing impurities in the air. For air purification, the membrane thickness and porosity will be further tuned and adjusted based on the characteristics of the air system.

### Redox Flow Battery

In another aspect, the double-layer ion-selective membranes of the disclosure can be incorporated into redox flow batteries. The redox flow batteries of the disclosure comprise an anode, a cathode, a double-layer ion-selective member between the anode and the cathode, and an electrolyte that interacts with the anode, cathode and the membrane.

In one embodiment of this aspect, the double-layer ion selective membranes can be incorporated into vanadium redox flow batteries. As described in the exemplification section, the electrochemical performance of the membrane was evaluated in a vanadium redox flow battery (VRFB). The nano-sized and tortuous pores of the PBN flakes can effectively block the crossover of vanadium ions and provide excellent ion selectivity based on the pore size exclusion mechanism. Furthermore, the super-acidic sulfonic acid groups of NAFION™ decorated on the nanoporous structure of PBN provide high-speed proton transfer channels that increase proton conductivity through both Grotthuss and vehicle mechanisms. The vanadium flow battery with the PBN-PEI membrane exhibited higher discharge capacity, Coulombic efficiency, voltage efficiency, and energy efficiency compared with the battery with the most common ion selective membrane (NAFION™ 115 membrane). The membrane achieved a high Coulombic efficiency of about 97.16% and outstanding energy efficiency of about 91.00% at 40 mA cm⁻² with a stable cycling performance for over 700 cycles at about 100 mA cm⁻².

### Definitions

It is to be understood that the terminology used herein is for describing particular embodiments only and is not intended to be limiting. Unless defined otherwise, all technical and scientific terms used herein have the same meaning as commonly understood by one of ordinary skill in the art to which the disclosure pertains.

Although any methods and materials similar or equivalent to those described herein may be used in the practice for testing of the present disclosure, exemplary materials and methods are described herein.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

As used in this specification and the appended claims, the singular forms “a,” “an,” and “the” include plural referents unless the content clearly dictates otherwise. The conjunctive term “and/or” between multiple recited elements is understood as encompassing both individual and combined options. For instance, where two elements are conjoined by “and/or,” a first option refers to the applicability of the first element without the second. A second option refers to the applicability of the second element without the first. A third option refers to the applicability of the first and second elements together. Any one of these options is understood to fall within the meaning, and therefore satisfy the requirement of the term “and/or” as used herein. Concurrent applicability of more than one of the options is also understood to fall within the meaning, and therefore satisfy the requirement of the term “and/or.”

Unless the context requires otherwise, throughout the specification and claims that follow, the word “comprise” and synonyms and variants thereof such as “have” and “include”, as well as variations thereof, such as “comprises” and “comprising”, are to be construed in an open, inclusive sense, e.g., “including, but not limited to.” The transitional terms “comprising,” “consisting essentially of,” and “consisting of” are intended to connote their generally accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element or step not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents) also provide as embodiments those independently described in terms of “consisting of” and “consisting essentially of.”

“About” means within an acceptable error range for the particular value as determined by one of ordinary skill in the art, which will depend in part on how the value is measured or determined, i.e., the limitations of the measurement system. Unless explicitly stated otherwise within the disclosure, claims, result or embodiment, “about” means within one standard deviation per the practice in the art, or can mean a range of ±20%, ±10%, ±5%, ±4, ±3, ±2 or ±1% of a given value. It is to be understood that the term “about” can precede any particular value specified herein, except for particular values used in the Examples. For example, “about” can mean a standard of deviation of ±1 μm, ±2 μm, ±3 μm, ±4 μm, ±5 μm, 6 μm, ±7 μm, ±8 μm, ±9 μm, ±10 μm for the membrane thickness.

“Ultrathin” describes an embodiment with a thickness of 10 nm-10000 nm.

“Tortuous” pores or “tortuosity” is defined as predicting transport properties of porous media such as rocks, soils, and membranes. The term describes pores microstructures and refers to the ratio of the diffusivity in the free space to the diffusivity in the porous medium. The effective diffusivity is proportional to the reciprocal of the square of the geometrical tortuosity. Further, a more “tortuous” path is described to separate mixtures over a longer period of time.

“Enmesh” means to entrap or entangle one material with another material such that the materials are not easily separated. An example of enmeshing includes but is not limited to NAFION™ being intermixed with PBN.

“Bifunctional” means an embodiment that contains multiple purposes or functions. An example of bifunctional includes but is not limited to the mixed PBN and NAFION™ layer that is ion-selective and ion-conductive.

“NAFION™ ” is a brand name for sulfonated tetrafluoroethylene-based fluoropolymer-copolymer, also known as perfluorinated sulfonic acid ionomers. NAFION™ is synthesized by copolymerization of tetrafluoroethylene and a derivative of a perfluoro(alkyl vinyl ether) with sulfonyl acid fluoride, which can be prepared by the pyrolysis of its respective oxide or carboxylic acid to give an olefinated structure. NAFION™ membranes are typical cation exchange membranes that are widely used in flow batteries. NAFION™ has polytetrafluoroethylene main chains and side chains with super-acidic sulfonic acid groups. “Super-acidic” is defined as an acid with an acidity greater than pure sulfuric acid, which has a Hammett acidity function of (H₀) of −12. Examples of super-acids include but are not limited to trifluoromethanesulfonic acid and fluorosulfuric acid. NAFION™ membranes are commonly categorized in terms of their equivalent weight (EW) and thickness. For example, NAFION™ 117 indicates an extrusion-cast membrane with 1100 g/mol EW and 0.007 inches (7 thou) in thickness.

All percents are intended to be weight percent unless otherwise specified. The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

### EXEMPLIFICATION

### High Ion Conductive and Selective Membrane Achieved Through Dual Ion Conducting Mechanisms

Conventional ion-selective membranes, e.g., ion-exchange and porous membranes, are unable to perform high conductivity and selectivity simultaneously due to the contradictions between their ion selecting and conducting mechanisms. In this work, a bifunctional layer was developed via the combination of nanoporous boron nitride (PBN) and ion exchange groups from NAFION™ to achieve high ion conductivity through dual ion conducting mechanisms as well as high ion selectivity. A one-step template-free method was adopted to synthesize PBN flakes. PBN is dispersed in isopropanol and functionalized simultaneously by sonication. PBN is further enmeshed with NAFION™ resin to form the bifunctional layer coated onto a porous polyetherimide membrane. The double-layer membrane exhibits excellent ion selectivity (1.49×10⁸ mS cm⁻³ min), which is 22 times greater than that of the pristine porous polyetherimide membrane, with maintained outstanding ion conductivity (64 mS cm⁻¹). In a vanadium flow battery, the double-layer membrane achieves a high Coulombic efficiency of 97% and outstanding energy efficiency of 91% at 40 mA cm⁻² with a stable cycling performance for over 700 cycles at 100 mA cm⁻². PBN with ion exchange groups may therefore offer a potential solution to the limitation between ion selectivity and conductivity in ion-selective membranes.

Introduction. Flow batteries have attracted considerable attention as a large-scale energy storage technology because of their unique feature of uncoupling power and energy, which allows the expansion of energy storage by increasing the volume or concentration of the electrolyte.^{[1]} Compared with other electrochemical technologies, such as lead-acid, lithium-ion, and sodium-based batteries, flow batteries have the advantages of long life, high safety, and low cost.^{[2]} An ion-selective membrane is an essential part of flow batteries. On the one hand, the membrane allows specific ions to pass through, maintaining a neutral charge in the cell.^{[3]} On the other hand, it prevents the crossover of active species to maintain the capacity. The properties of the ion-selective membrane have a significant impact on the flow battery's performance. The ideal ion-selective membranes should have high ion conductivity and selectivity, high chemical stability, good mechanical strength, and low cost.^{[4]}

Based on their ion-selective mechanisms, conventional ion-selective membranes can be classified into ion-exchange and porous membranes.^{[4-5]} The ion-exchange membranes contain anion (cation exchange membranes) or cation (anion exchange membranes) groups, allowing ion conductivity and selectivity based on the Donnan exclusion mechanism.^{[5b]} The NAFION™ membrane is one of the most common cation exchange membranes used in flow batteries. NAFION™ consists of polytetrafluoroethylene main chains and side chains containing superacidic sulfonic acid groups.^{[6]} Hydrophilic sulfonic acid groups constitute ion-transmission channels that provide excellent cation conductivity. However, NAFION™ membranes have a heavy crossover issue due to the large amount of cation active species involved, as well as the high cost of the NAFION™ membranes hindering the commercial application.^{[3, 7]} Sulfonated poly (ether ether ketone) (SPEEK) is an attractive ion exchange membrane with relatively low cost and high stability.^{[8]} In comparison with NAFION™, SPEEK has a higher ion selectivity because of the less acidic sulfonic acid groups and hydrophobic PEEK backbone; however, the ion conductive channels are relatively tortuous.^{[9]} Normally, a high sulfonation degree of SPEEK is required in order to achieve sufficient ion conductivity. However, this can lead to swelling, decreases stability, as well as reduced ion selectivity^{[6, 9]}. Over the past decade, porous membranes prepared through non-solvent induced phase separation (NIPS) have been used as ion-selective membranes in flow batteries because of their low cost and high ion conductivity.^{[10]} The ion selectivity is governed by the pore size exclusion mechanism. These membranes exhibit asymmetric finger-like pores in the vertical direction with thin surface layers on the top and bottom of the membranes. Vertical finger-like pores provide excellent and unhindered ion transfer, and the ion selectivity is mainly attributable to the pore morphology in the surface layer.^{[10]} Ideally, a dense and thick surface layer should be formed to achieve high ion selectivity, but in doing so it also reduces the size and density of the vertical pores, which is detrimental to the ion conductivity of the membrane.^{[10c]} Traditional ion-exchange and porous membranes are both based on a single ion-selective mechanism which requires a trade-off between ion selectivity and conductivity.

Boron nitride (BN), also known as white graphite, exhibits superior chemical and thermal stability, high thermal conductivity, and excellent electrical insulating properties.^{[11]} Further to the advantages of BN, porous BN (PBN) has a unique ability to adjust nanoporosity, thus being useful for multiple applications, such as absorption, separation, and chemical conversion.^{[12]} With its high nanoporosity and stability, PBN has the potential to be an attractive material for ion selective. PBN can be obtained through three bottom-up methods: chemical blowing,^{[13]} template-based,^{[14]} and template-free^{[15]} techniques. The template-free approach has several advantages over chemical blowing or template-based approaches, including a simple synthesis procedure, low costs, and relatively low toxicity.^{[16]} PBN is synthesized by reacting boron-containing and excess nitrogen-containing precursors at high temperatures. Nanopores are formed through the decomposition and release of excess nitrogen precursors during the synthesis process.^{[15f]} The porosity and morphology of PBN can be tailored by varying different types or proportions of precursors and changing reaction conditions.^{[15b, 15e]}

Inspired by the features of different ion-selective membranes and PBN, a double-layer ion-selective membrane with a unique PBN bifunctional ion-selective layer on a low-cost and highly ion-conductive porous polyetherimide (PEI) layer was developed. As a first step, PBN was synthesized using a template-free method with a stacked flake-like nanoporous structure. The hydrophilicity and crystallinity of the PBN flakes were significantly increased after sonication of the PBN flakes in isopropanol, as showed by X-ray diffraction (XRD), Fourier transform infrared (FTIR) spectroscopy, thermogravimetric analysis (TGA), and contact angle measurements. The nanoporosity of PBN was characterized using the N₂ adsorption-desorption technique and calculated using non-local density functional theory (NLDFT). PBN was further mixed with NAFION™ resin and spray-coated onto the porous PEI membrane prepared by the NIPS method to form a PBN-PEI double-layer membrane. The morphology and properties of the PBN-PEI membrane were investigated in order to identify its ion-selective and ion-conductive mechanisms. Furthermore, the electrochemical performance of the membrane was evaluated in a vanadium redox flow battery (VRFB). The unique PBN bifunctional ion-selective layer with the nanoporous structure and ion-exchange groups overcomes the limitation between ion conductivity and selectivity in conventional ion-selective membranes. More importantly, the overlap of the novel bifunctional PBN ion selective layer with the low-cost high ion-conducting PEI layer demonstrated superior performance due to its ability to integrate the advantages of both layers.

Results and discussions. FIG. 1A illustrates the functionality of the PBN-PEI double-layer membrane in a VRFB, which allows proton transfer and suppresses the crossover of vanadium ions. The PEI layer was prepared using the NIPS method with an extensive network of longitudinal unimpeded finger-like pores, resulting in superior ion conductivity (FIG. 1B). In addition, the PEI layer provides good mechanical support for the PBN layer. The PBN layer is composed of PBN flakes decorated with NAFION™ resin (FIG. 1C). Accordingly, the nano-sized and tortuous pores of the PBN flakes can effectively block the crossover of vanadium ions and provide excellent ion selectivity based on the pore size exclusion mechanism. Furthermore, the super-acidic sulfonic acid groups of NAFION™ decorated on the nanoporous structure of PBN provide high-speed proton transfer channels that increase proton conductivity through both Grotthuss and vehicle mechanisms (FIG. 1D).^{[17]} Furthermore, the double-layer design of the PBN-PEI membranes with a low-cost PEI supporting layer and a thin (5 μm) PBN ion-selective layer, results in a significant reduction of cost when compared to the NAFION™ 115 membrane (Table 1), which can be beneficial to the commercialization and advancement of PBN-PEI membranes. Overall, the PBN-PEI membrane exhibits high ion selectivity, ion conductivity, stability, and low cost.

TABLE 1
Material Cost Calculation for 1 m² 50% PBN-PEI Membrane
and corresponding comparison with commercial NAFION ™ 115
membrane
Material Cost for 50% PBN-PEI Membrane for 1 m²

| | Price/ | | | Total |
|---|---|---|---|---|
| Material | Unit¹ | Qty. | | Price |
| Boric acid (H₃BO₃, 99.8%, Alfa | $0.022/g | 20 | g | $0.44 |
| Aesar) ² | | | | |
| Urea (Certified ACS, Fisher | $0.067/g | 100 | g | $6.70 |
| Chemical) ² | | | | |
| NAFION ™³ | $7.65/g | 10 | g | $76.50 |
| Polyetherimide (PEI, Sigma-Aldrich) | $0.317/g | 31 | g | $9.83 |
| Polyvinylpyrrolidone (PVP, Alfa Aesar) | $0.20/g | 3.4 | g | $0.68 |
| 1-methyl-2-pyrrolidinone (NMP, | $0.041/g | 103 | g | $4.22 |
| Sigma-Aldrich) | | | | |
| | | | | $98.37 |

Commercial Price of NAFION ™ 115 Membrane for 1 m²

| | Price/ | | Total |
|---|---|---|---|
| Material | Unit | Qty. | Price |
| NAFION ™³ | $7.65/g | 250 g | $1912.50 |
| | | | $1912.50 |

¹Calculated according to the price listed on Quatzy.com.
² The yield of PBN is calculated by 50%
³Calculated according to the price from Ion Power Inc. for 0.09 m² NAFION ™ 115 membrane

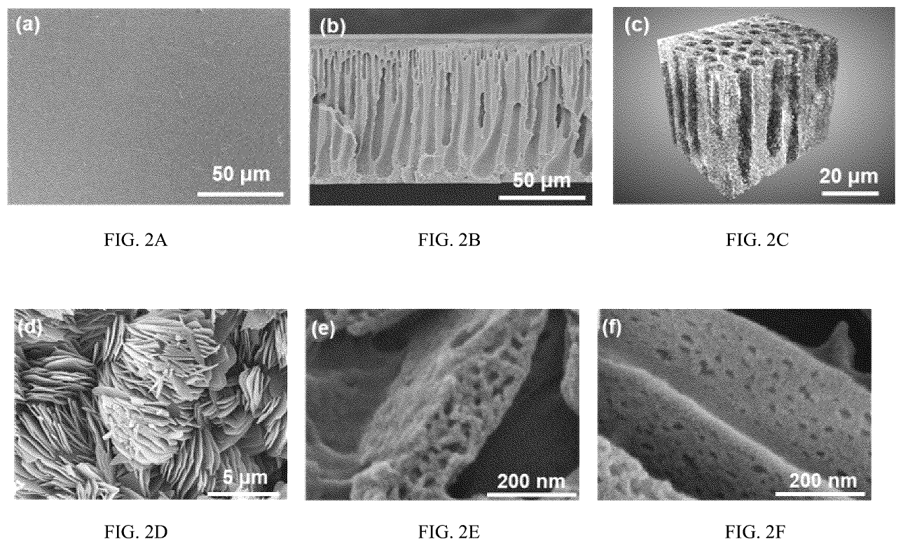

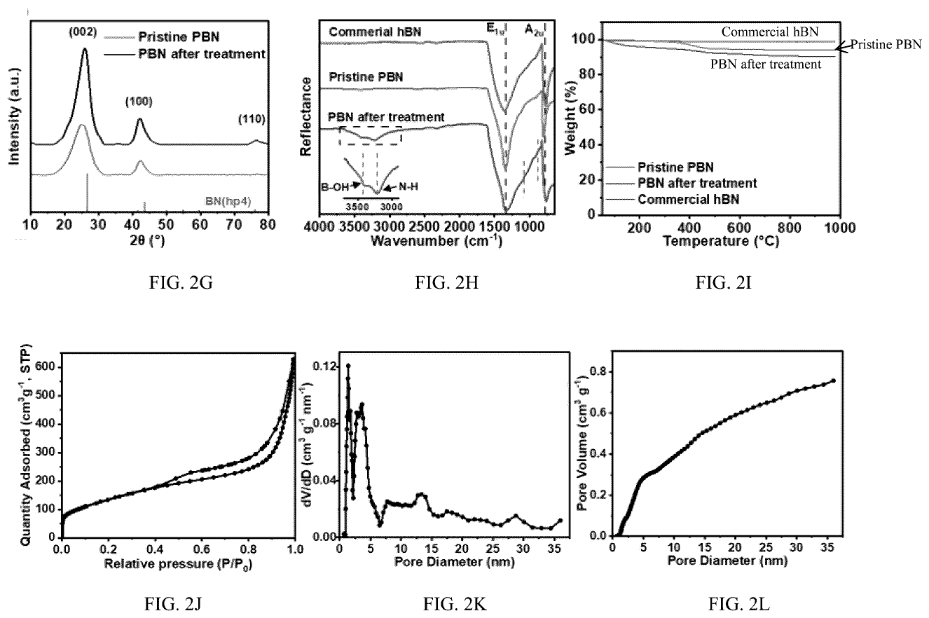

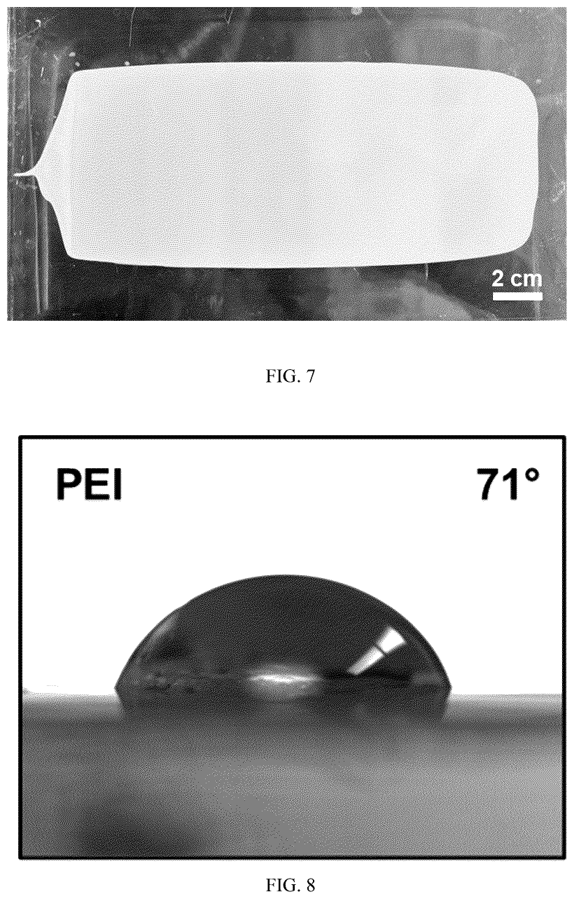

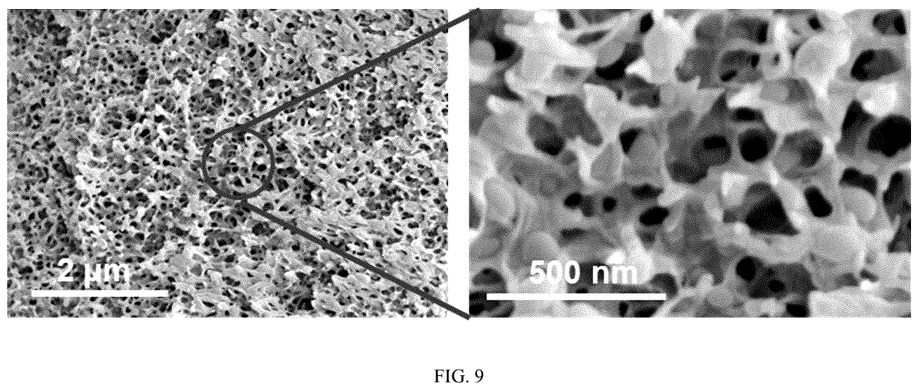

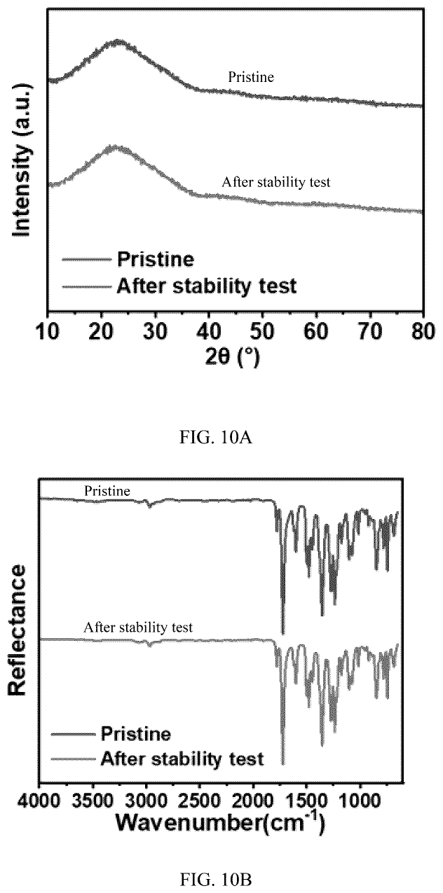

For the preparation of the low-cost and highly ion-conductive PEI membrane using the NIPS method, 75 wt. % 1-methyl-2-pyrrolidinone was added as the non-solvent phase. In addition, polyvinylpyrrolidone (PVP) was added to further improve ion conductivity.^{[10d]} The porous PEI membrane presented a smooth and flat surface (FIG. 7) with a contact angle of 71° (FIG. 8). The scanning electron microscopy (SEM) images (FIGS. 2A and 2B) revealed a flat top surface and a porous cross-section with asymmetric finger-like pores in the PEI membrane. The PEI membrane's three-dimensional structure was reconstructed using micro X-ray computed tomography (XCT), as illustrated in FIG. 2C. The unobstructed channels of the well-aligned asymmetric finger-like pores provided excellent ion conductivity. Furthermore, the high-magnification SEM image (FIG. 9) revealed the presence of a substantial number of secondary pores on the pore walls. These secondary pores further enhanced the ion conductivity and provided a limited or low level of ion selectivity to the porous PEI membrane. The PEI membrane was exposed for one week to acidic vanadium electrolyte and characterized using XRD and FTIR (FIG. 10) to determine its chemical stability. It was found that no apparent differences were observed, demonstrating that the PEI membrane could be used as the support layer in a strongly acidic environment.

PBN was synthesized by the template-free method with a precursor of boric acid and excess urea through the reactions as shown in Equations (1), (2), and (3):^{[12c, 15c, 15f]}

2H₃BO₃≙B₂O₃+3H₂O↑ (1)

NH₂CONH₂≙NH₃↑+HNCO↑ (2)

B₂O₃+NH₃≙2BN+3H₂O↑ (3)

The nanoporosity is attributed to the generation and release of gaseous products during the reaction.^{[15f]} As shown in the SEM image (FIG. 2D), the PBN consists of multiple stacked PBN flakes. High-magnification SEM images of the PBN flakes (FIGS. 2E and 2F) reveal continuous nanoporous structures throughout their cross-section and surface.

PBN flakes were obtained by grinding and sonicating pristine PBN in isopropanol, followed by centrifugation and filtration. In addition, PBN was also surface functionalized during the sonication process. PBN was compared before and after treatment, using SEM, XRD, FTIR, and TGA results to investigate the effects and mechanisms of treatment. FIG. 2G shows the XRD spectra of PBN before and after treatment with three characteristic peaks corresponding to the (002), (101), and (110) planes of hexagonal BN (hBN) (PDF #45-0894). The broad characteristic peaks show that PBN contained amorphous BN. As a result of the treatment, the peak (002) became sharper and the full-width half maximum of the peak decreased from 5.953 to 5.066, indicating the removal of some amorphous BN. The crystallinity of PBN increased from 12.26% to 18.62% as calculated based on the (002) peak by Jade XRD software.

According to the FTIR spectra shown in (FIG. 2H), BN typically has two characteristic peaks: the E₁ᵤ peak at 1403 cm⁻¹ produced by in-plane oscillation within the BN plane (B—N stretching) and the A₂ᵤ peak at 808 cm⁻¹ caused by the c-axis vibration (B—N—B bending).^{[18]} After treatment, the intensity ratio of A₂ᵤ and E₁ᵤ of PBN increased and was comparable to that of hBN. It appears that PBN exhibits more characteristics of hBN as a result of the decomposition of some amorphous BN during the treatment process, as confirmed by the XRD analysis. Following the treatment, two broad peaks were observed at 3000-3600 cm⁻¹, which corresponded to the B—OH and N—H stretching, respectively.^{[19]} The peaks at 1100 and 992 cm⁻¹ are related to the B—O linkage.^{[11]} The appearance and strengthening of these peaks indicated the successful introduction of the hydroxyl and amino groups into PBN. The process of the functionalization of PBN is similar to the edge functionalization of hBN, where the solvent molecules attack the B—N bonds near the defects or edges, and the functional groups are introduced upon exposure of the new edges.^{[20]} As amorphous BN contains a significantly higher ratio of defects than hBN, functionalization is more efficient.^{[13b]}

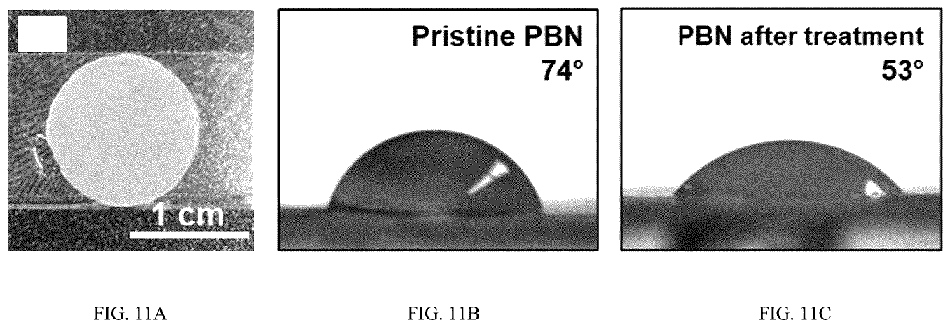

TGA was performed to further verify the functionalization of PBN. Compared to commercial hBN, pristine PBN showed an approximate weight loss of 4.8% as a result of the thermal degradation of some amorphous BN after 300° C. Nevertheless, the treated PBN lost 4.9% of its weight loss before 300° C., indicating the functional groups had successfully been introduced (FIG. 2I).^{[11]} The PBN after treatment exhibited excellent thermal stability and maintained 90% of its initial weight at 1000° C. The hydrophilic properties of pristine and treated PBN were evaluated by compressing them into pallets and measuring their contact angles (FIG. 11A).^{[21]} The contact angle of PBN after treatment was significantly smaller than that of pristine PBN, as shown in FIGS. 11B and 11C, which suggests the improved hydrophilicity of PBN with the introduction of hydroxyl and amino groups after treatment.

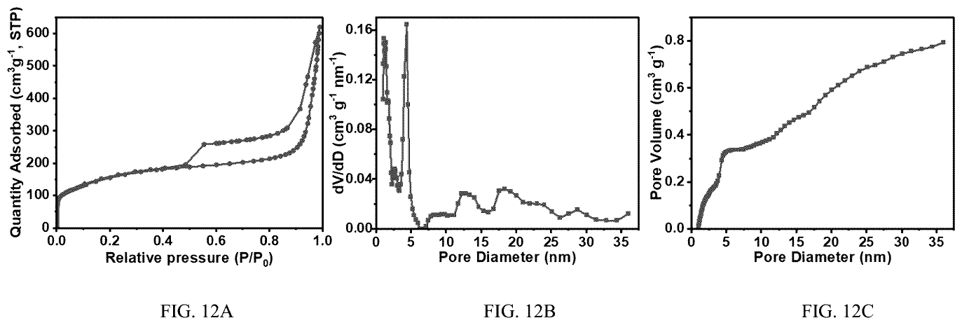

The pore size distribution (PSD) and porosity of the PBN were evaluated by the N₂ adsorption-desorption method. Based on the standards of the International Union of Pure and Applied Chemistry (IUPAC), both pristine and treated PBN exhibited type I and IV isotherms with type H3 and H4 hysteresis loops (FIG. 12A and FIG. 2J),^{[22]} which indicate the presence of micropores and mesopores with spherical and split morphologies in PBN. The NLDFT method was used to calculate the PSDs of the PBNs.^{[15d]} The pristine PBN exhibited a bimodal PSD with several broad peaks in the 10-35 nm range (FIG. 12B), which are consistent with the pores observed in the SEM image (FIGS. 2E and 2F). After treatment, PBN still exhibited a bimodal PSD, in which the right peak became broader but lower and left-shifted to 3.3 nm (FIG. 2K). The change in the PSDs and analysis of the treatment process indicate that a certain volume of pores is provided by the amorphous component of PBN. During the treatment process, some of the loose amorphous part was decomposed, and the firmer amorphous part with smaller pore sizes was left. As shown in FIG. 2L, the pore volume of the PBN after treatment, the mesopore volume was maintained at 0.76 cm³ g⁻¹, and approximately 37% of the pores were smaller than 5 nm (0.28 cm³ g⁻¹), further supporting that PBN has an excellent ion selectivity based on the pore size exclusion mechanism.

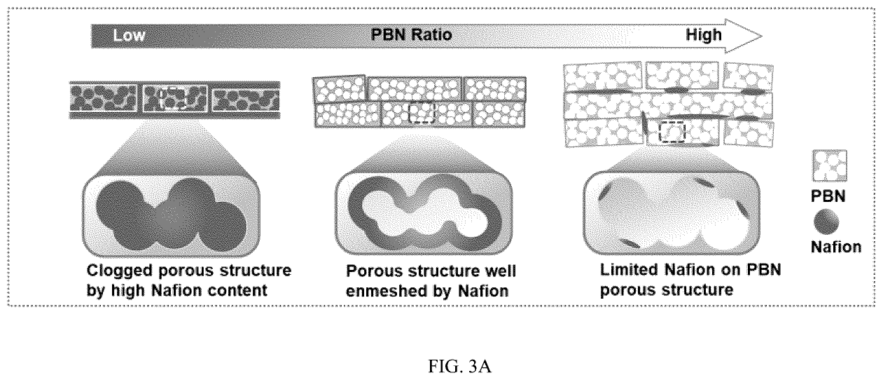

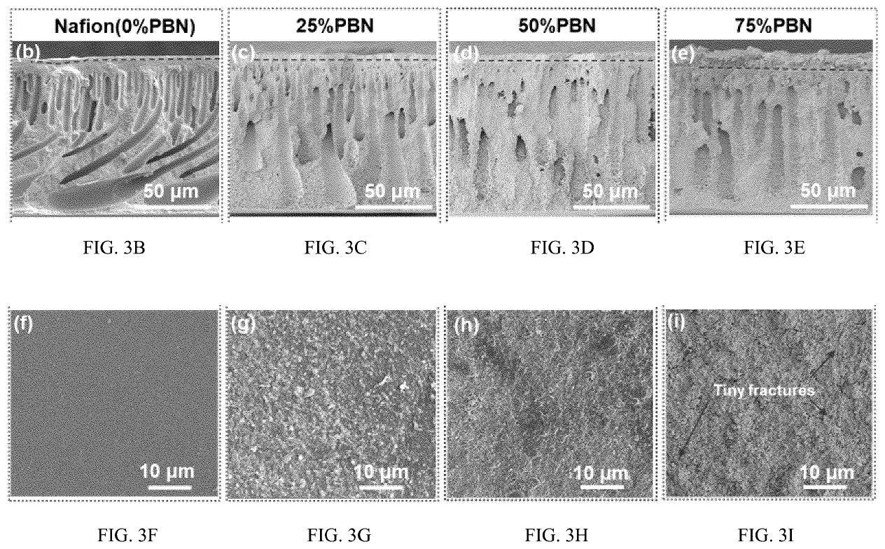

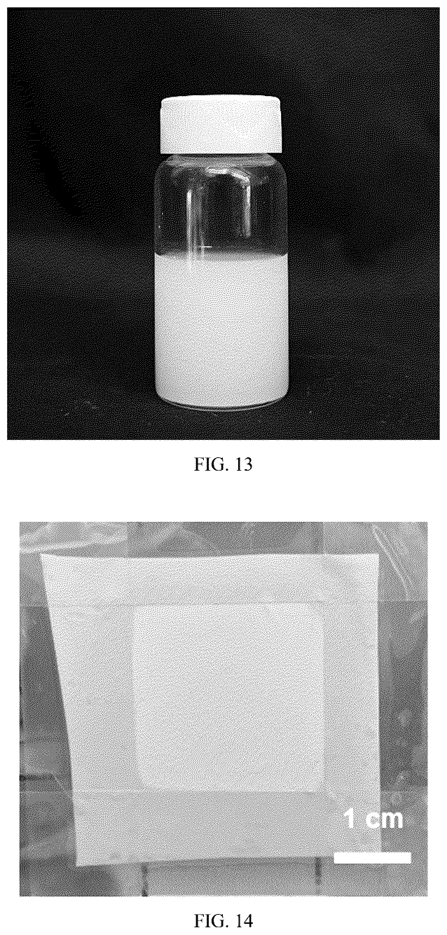

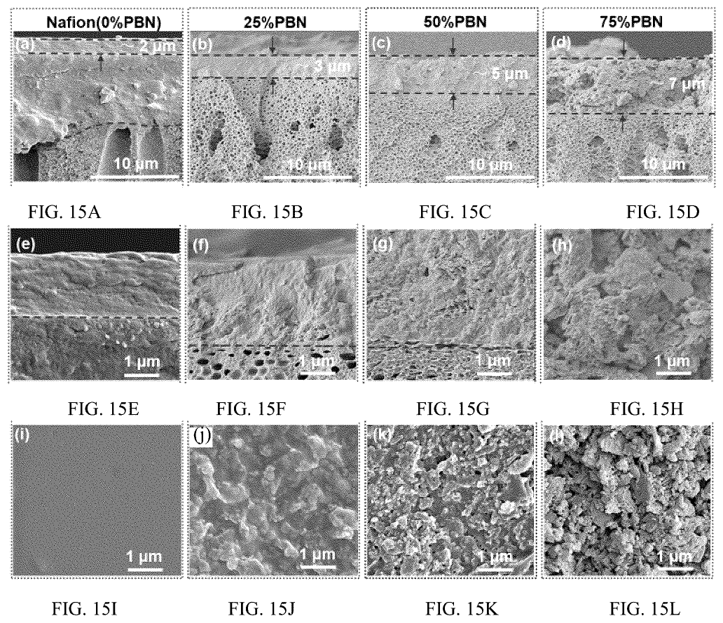

PBN was further mixed with NAFION™ resin as a binder and ion exchange group supplier to form the bifunctional ion-selective layer, as shown in FIG. 13 and FIG. 14. The ratio of PBN to NAFION™ directly affects the morphology and properties of the PBN layer (FIG. 3A). To explore the optimal ratio, three PBN layers with different PBN-NAFION™ weight ratios (25%, 50%, and 75%) were prepared (as shown in Table 2). As a means of evaluating the contribution of NAFION™ resin, a NAFION™-PEI (0% PBN-PEI) membrane was also prepared. SEM was used to evaluate the morphologies of the pure NAFION™ (0% PBN) layer and PBN layers with different PBN ratios. PBN and NAFION™ were uniformly deposited on the top surface of the PEI membranes, as shown in FIGS. 3B-3E. The thicknesses of the NAFION™, 25% PBN, 50% PBN, and 75% PBN layers were around 2, 3, 5, and 7 μm, respectively (FIGS. 15A-D) because of the difference in the densities of the PBN and NAFION™ resin. An interface layer, in addition to the 2 μm coating layer, was observed on the cross-section of the NAFION™-PEI membrane due to the infiltration of the NAFION™ resin into the PEI membrane (FIG. 15A). The 25% PBN and 50% PBN layers appeared dense cross-sectional morphologies with no distinct gaps (FIG. 15F, 15G). The cross-section of the 75% PBN layer (FIG. 15H) was less condensed with due to the lower amount of NAFION™ resin. FIGS. 3F-3I are the SEM images of the top surfaces of the coating layers. The NAFION™ (0% PBN) layer shows a flat and nonporous surface (FIG. 3F). There were tiny fissures observed on the top surface of the 75% PBN layer (FIG. 3I) as a result of the limited NAFION™ resin (25%), which was unable to tightly bind the PBN flakes together. FIGS. 15G-15L show high-magnification images of the 25%, 50%, and 75% PBN layers, which exhibit different morphologies. As can be seen in FIG. 15G, the top surface of the 25% PBN layer was fully covered with NAFION™ resin, with no visible gaps or pores. In the case of the 50% PBN layer (FIG. 15K), the PBN flakes were well enclosed by the NAFION™ resin with very few pores and openings visible. In the 75% PBN layer (FIG. 15I), the top surface was rougher, and it is difficult to detect the presence of NAFION™ resin.

TABLE 2
Notation for PBN-PEI membranes prepared
under different PBN ratios

| | PBN- | Total nonvolatile | Thickness of | |
|---|---|---|---|---|
| | NAFION ™ | mass in the | the Coating | Total |
| | ratios | suspensions | layer | Thickness |
| | (weight) | (mg cm⁻²) | (μm) | (μm) |
| PEI | — | — | — | 100 ± 3 |
| 25% PBN- | 1:3 | 2 | 3 ± 1 | 103 ± 4 |
| PEI | | | | |
| 50% PBN- | 1:1 | 2 | 5 ± 1 | 105 ± 4 |
| PEI | | | | |
| 75% PBN- | 3:1 | 2 | 7 ± 1 | 107 ± 4 |
| PEI | | | | |
| NAFION ™- | 0:1 | 2 | 2 ± 1 | 102 ± 4 |
| PEI | | | | |

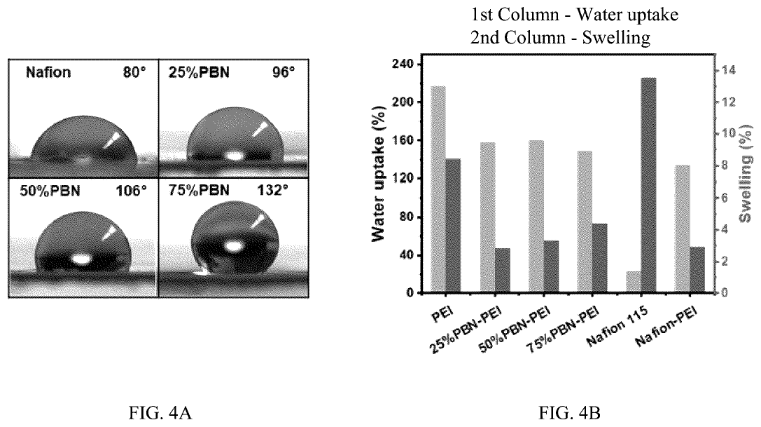

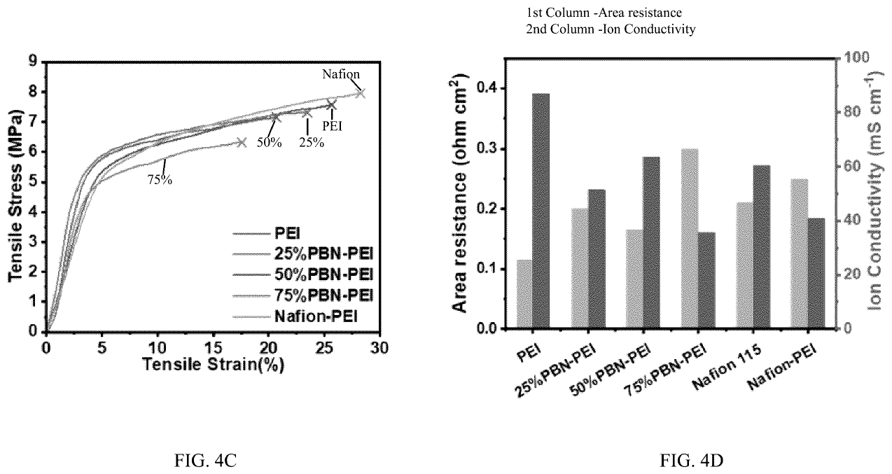

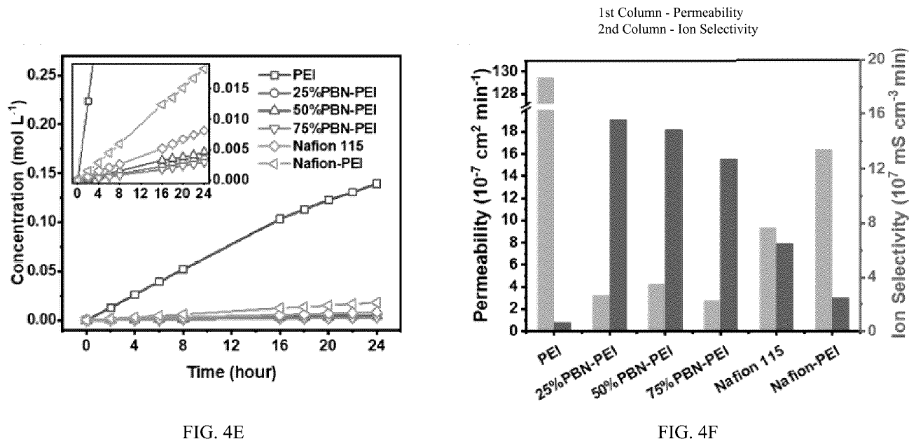

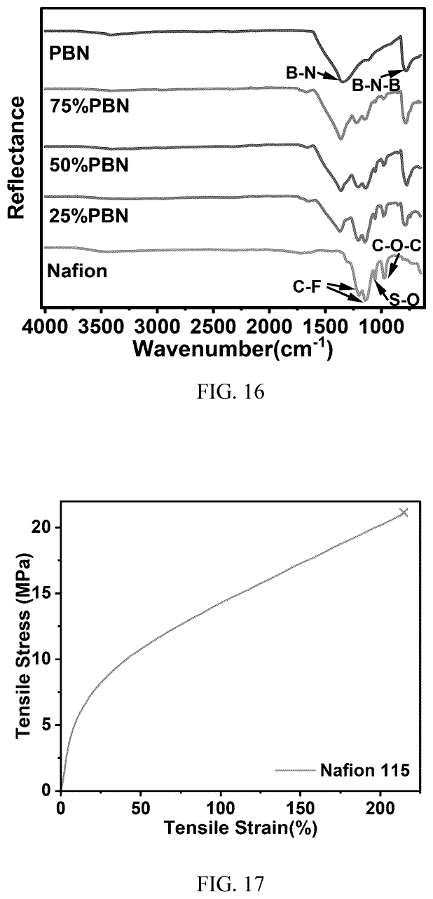

PBN-PEI membranes were characterized to determine their composition, hydrophilicity, water uptake, swelling ratio, ion conductivity, ion selectivity, and mechanical strength. Based on the FTIR spectrum (FIG. 16), all PBN layers exhibit peaks corresponding to the composition of PBN and NAFION™, demonstrating the successful coating of the PBN layers. Contact angle measurements were used to characterize the hydrophilicity of the PBN layers. As a result of the hydrophobicity of PBN and the roughness of the surface, the contact angles of the PBN layers increase with the rise in the PBN ratio (from 25% to 75%), as shown in FIG. 4A. The water uptake and swelling ratios are shown in FIG. 4B. The water uptake of the PBN-PEI membranes is primarily attributed to the PEI layer because of the high porosity of the PEI layer and the extreme thinness of the PBN layer. This results in similar water uptake values of the membranes. The nonporous structure of the NAFION™ coating layer and the filled interface layer contribute to the slightly lower water uptake of the NAFION™-PEI membrane. In terms of the swelling ratio, all PBN-PEI membranes exhibited lower swelling ratios than pristine PEI and NAFION™ 115 membranes because the rigid PBN flakes suppressed the movement of the polymer chains in the PBN layer. The swelling ratio of the PBN-PEI membrane slightly increased with an increase in the PBN ratio. This is because less NAFION™ could not provide the mechanical strength in the PBN layer to fully resist the swelling of the PEI membrane. Correspondingly, small fractures can also be seen in the SEM image of the top surface of the 75% PBN-PEI layer (FIG. 3C). NAFION™-PEI membrane also presented a lower swelling ratio than the pristine PEI and NAFION™ 115 membranes due to the filled interface layer restricting the shrinkage after dehydration.

The mechanical properties of the membrane strongly influenced long-term stability. Good mechanical properties such as high tensile strength and ductility help to prevent membrane deterioration resulting from structural damage during use. The stress-strain curves for the pristine PEI, PBN-PEI, and NAFION™ 115 membranes are shown in FIG. 4C and FIG. 17. Despite the high porous nature of the pristine PEI membrane, the membrane still retains a ductile behavior with good tensile strength (7.58 MPa at 25.7%). The 25% PBN-PEI and 50% PBN-PEI membranes showed higher Young's moduli (176 and 158 MPa, respectively), compared to the pristine PEI and NAFION™-PEI membranes (130 and 119 MPa). However, a slightly lower tensile strength and elongation at break (7.30 MPa at 23.47% and 7.16 MPa at 20.68%) was noted. The 25% PBN and 50% PBN layers exhibit increased hardness and lower elasticity compared with the pristine PEI and NAFION™-PEI membranes. Despite a fragile morphology observed in the SEM images for the 75% PBN-PEI membrane (FIG. 7H, 3P), the membrane still exhibited a satisfactory tensile strength (6.32 MPa), indicating that the PEI layer provided sufficient structural support. Consequently, PBN-PEI membranes are advantageous for VRFB stability due to their favorable mechanical properties.

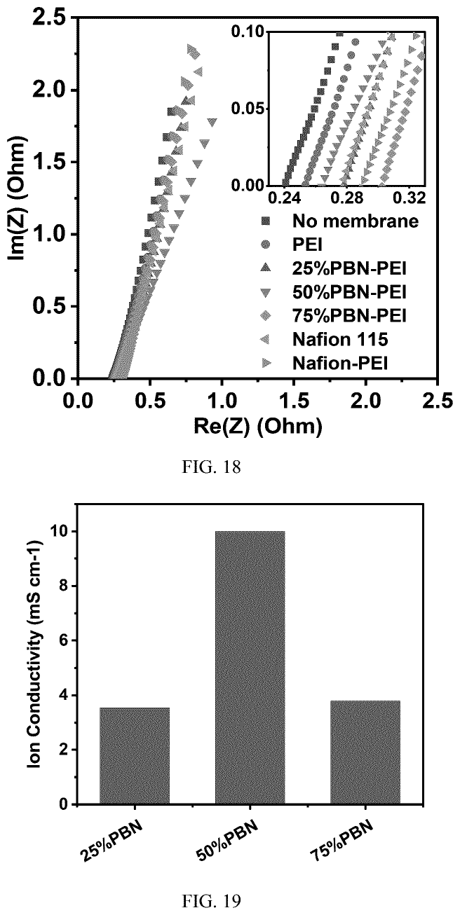

Ion conductivity and selectivity are the most significant characteristics of ion-selective membranes, which determine the area resistance and ion permeability of the membrane, thereby affecting the electrochemical performance of the flow battery. The high-frequency impedances of all membranes were measured using electrochemical impedance spectroscopy (FIG. 18) and the area resistance and ion conductivity were calculated, as shown in FIG. 4D. The pristine PEI membrane exhibited the highest ion conductivity (87 mS cm⁻¹) and lowest area resistance (0.115 (2 Ωcm²) of all membranes owing to the unimpeded ion transfer channels provided by a large number of vertical finger-like pores. It was found that the area resistance of the PBN-PEI membranes increased after the PBN layers were coated. Nevertheless, the ion conductivity and area resistance did not correlate linearly with the PBN ratio. The 50% PBN-PEI membrane had the highest ion conductivity (64 mS cm⁻¹) and lowest area resistance (0.165 Ωcm²) among all other PBN-PEI membranes. The 25% PBN-PEI, 75% PBN-PEI, and NAFION™-PEI membranes exhibited lower ion conductivities of 52, 36, and 41 mS cm⁻¹, and higher area resistances of 0.200, 0.295, and 0.250 Ωcm², respectively. The ionic conductivity of the PBN layers can be evaluated by subtracting the areal resistance of the pristine PEI membrane from that of the PBN-PEI double-layer membrane, assuming the PBN and PEI layers are connected in series. Further calculations of the ion conductivities of PBN layers are shown in FIG. 19. Compared to 25% PBN and 75% PBN layers, the 50% PBN layer exhibits a much higher ion conductivity.

Using the morphology and properties of the PBN-PEI membranes, a relationship between the PBN ratio and ion conductivity was examined. NAFION™ resin with super acidic sulfonic acid groups was successfully introduced into the PBN structure in all the PBN layers. It was found that when the PBN ratio was too low, i.e., with a high NAFION™ content, the NAFION™ resin clogged the porous structure. Consequently, the rigid structure of PBN could not provide additional space for the sulfonic acid groups to uptake water, resulting in limited proton conductivity.^{[23]} With a medium PBN ratio, the PBN structure was still well enmeshed by the NAFION™ resin with sufficient space for sulfonic acid groups to uptake water. This resulted in excellent proton conductivity based on both the vehicle and Grotthuss mechanisms.^{[17]} With an excessively high PBN ratio, the limited sulfonic acid groups and hydrophobicity did not provide high proton conductivity. Due to the nonporous layers in the NAFION™-PEI membrane, proton transfer channels based on pores were blocked, resulting in a decrease in ion conductivity. Hence, the PBN layer with an appropriate PBN ratio was able to efficiently utilize the ion-exchange groups from the NAFION™ resin and maintained its porous structure to provide excellent ion conductivity.

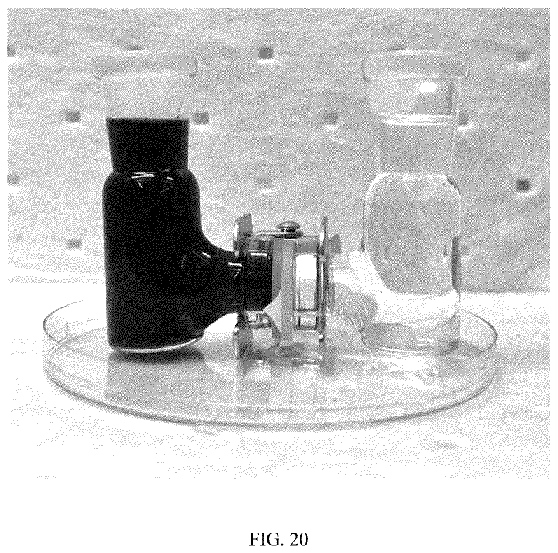

The vanadium (IV) permeabilities of all the membranes were calculated based on the results of the vanadium penetration test (FIG. 4E) in an H-cell (FIG. 20). The permeabilities of all the membranes are shown in FIG. 4F. The PEI membrane experienced a heavy crossover issue with the highest permeability (129×10⁻⁷ cm² min⁻¹) because the vertical unblocked pores could not impede the crossover of the vanadium ions. The PBN-PEI membranes exhibit significantly lower permeabilities (3.29×10⁻⁷, 4.27×10⁻⁷, and 2.80×10⁻⁷ cm² min⁻¹ for the 25% PBN-PEI, 50% PBN-PEI, and 75% PBN-PEI membrane) than that of the pristine PEI and NAFION™ 115 (9.34×10⁻⁷ cm² min⁻¹) membranes, which indicates that the PBN layer effectively prevented the crossover of the vanadium ions owing to its nanoporous structure and hydrophobicity. In contrast, the pure NAFION™ coating on the NAFION™-PEI membrane is only able to limit the crossover of the vanadium ions to a small extent and still exhibits high permeability (16.41×10⁻⁷ cm² min⁻¹). Furthermore, based on the morphology, thickness, and hydrophilicity discussed above, the 25% PBN layer was more clogged, whereas the 75% PBN layer was more hydrophobic and thicker. This resulted in a slightly lower permeability for the 25% PBN-PEI and 75% PBN-PEI membranes than the 50% PBN-PEI membrane.

The ion selectivity of the membranes was calculated, as shown in FIG. 4F. The ion selectivity of the 25% PBN-PEI (1.56×10⁸ mS cm⁻³ min), 50% PBN-PEI (1.49×10⁸ mS cm⁻³ min), and 75% PBN-PEI (1.27×10⁸ mS cm⁻³ min) membranes are approximately 20 times higher than that of the pristine PEI membrane (6.71×10⁶ mS cm⁻³ min) and also much higher than that of NAFION™ 115 (6.48×10⁷ mS cm⁻³ min) and NAFION™-PEI (2.49×10⁷ mS cm⁻³ min) membranes, which further demonstrates the high contribution of the PBN layer to the ion selectivity of the double-layer membrane. Moreover, the ion selectivity of the PBN-PEI membrane increased with a decrease in the PBN ratio. This phenomenon indicates that the NAFION™ resin modified the size of the gaps between the PBN flakes and pores in the PBN structure, thereby further affecting the ion selectivity of the PBN-PEI membrane. In comparison with NAFION™ 115, the 50% PBN-PEI membrane exhibited lower area resistance, enhanced ion conductivity, lower vanadium permeability, and higher ion selectivity. This resulted in its superior performance when used in VRFBs.

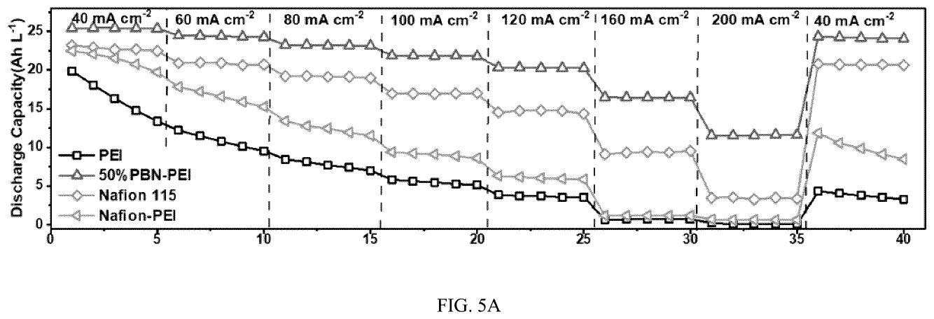

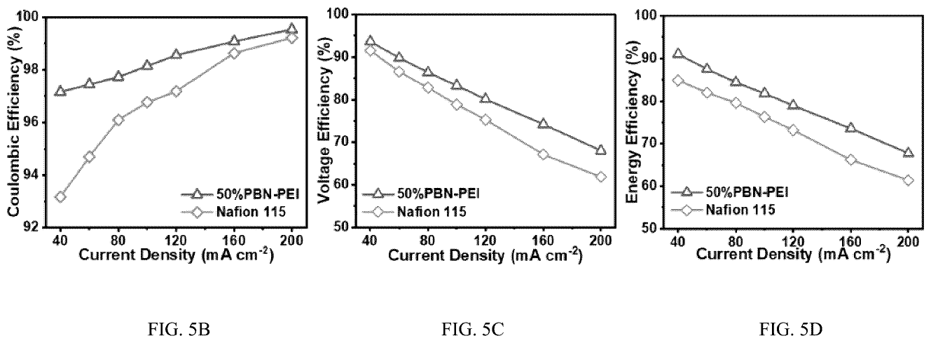

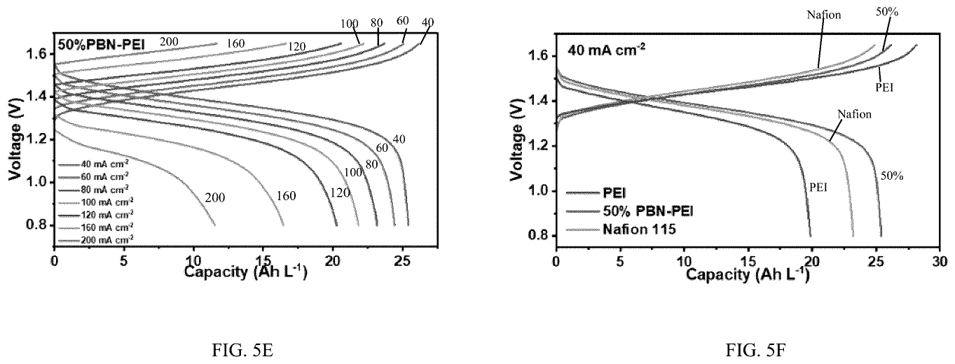

Since the excellent properties of the 50% PBN-PEI membrane, the comprehensive electrochemical performance of the membrane was further evaluated in the VRFB and compared with those of the PEI, NAFION™-PEI, and NAFION™ 115 membranes. The discharge capacities are shown in FIG. 5A. As expected, the battery assembled with the 50% PBN-PEI membrane exhibited the best rate performance and highest discharge capacities at all current densities (25.4, 24.4, 23.2, 21.8, 20.3, 16.5, and 11.7 Ah L⁻¹ at 40, 60, 80, 100, 120, 160, and 200 mA cm⁻², respectively) owing to its excellent ion conductivity and selectivity. As a result of the heavy crossover issue, the PEI and NAFION™-PEI membranes could not complete the rate performance test, during which the volumes of the electrolytes on both sides significantly changed.

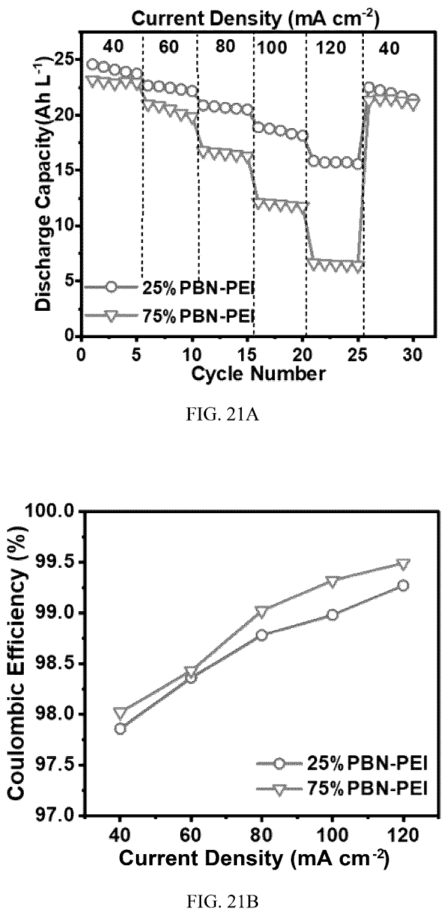

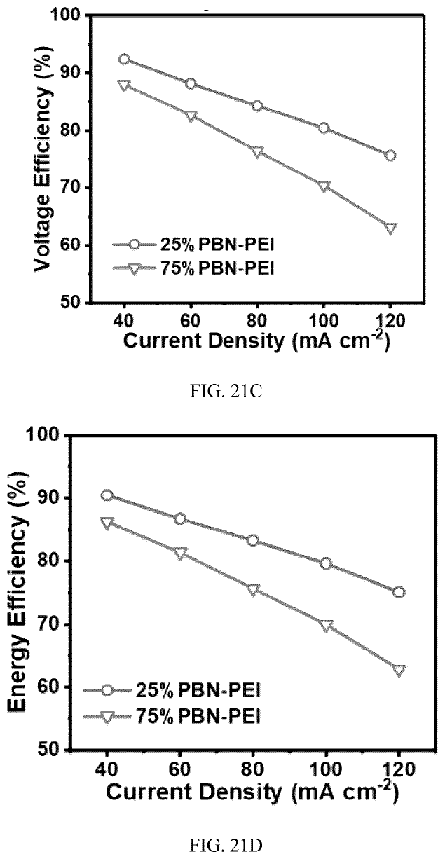

The Coulombic efficiency (CE), voltage efficiency (VE), and energy efficiency (EE) of the PEI, 25% PBN-PEI, 50% PBN-PEI, 75% PBN-PEI, NAFION™ 115, and NAFION™-PEI are listed in Table 3. The rate performance of 25% PBN-PEI and 75% PBN-PEI membranes were plotted in FIG. 21. The efficiencies of 50% PBN-PEI and NAFION™ 115 membrane were further compared (FIGS. 5B-5D). The CE of the membranes increased at a higher rate because of the lower vanadium crossover with shorter charge and discharge times (FIG. 5B). The 50% PBN-PEI membranes demonstrated substantially greater CEs than the NAFION™ 115 membrane, which is consistent with its lower permeability. The VEs of all membranes exhibited a decreasing trend with increasing current density (FIG. 5C) because of the increased ohmic loss and electrochemical reaction resistance at higher current densities.^{[24]} For each membrane, the area resistance controlled the ohmic potential drop across the membrane, which further affected the VE.^{[17]} Therefore, the 50% PEI-PBN membrane exhibited superior VE than the NAFION™ 115 membrane. The EEs are shown in FIG. 5d. Consequently, owing to the excellent CE and VE, the 50% PBN-PEI membrane provided the highest EE at all rates (91.10%, 87.50%, 84.41%, 81.77%, 78.94%, 73.55%, and 67.72% at 40, 60, 80, 100, 120, 160, and 200 mA cm⁻², respectively). Overall, the 50% PBN-PEI membrane exhibited superior performance compared to the pristine PEI and NAFION™ 115 membranes.

TABLE 3
Coulombic efficiency, voltage efficiency, and energy
efficiency for PEI, 50% PBN-PEI, and NAFION ™ 115
membranes at different rates

| Current | | 25% | 50% | 75% | | |
|---|---|---|---|---|---|---|
| Density | | PBN- | PBN- | PBN- | NAFION ™ | NAFION ™- |
| (mA cm⁻²) | PEI | PEI | PEI | PEI | 115 | PEI |
| | Coulombic Efficiency (%) | | | | | |
| 40 | 70.51 | 97.86 | 97.16 | 98.02 | 93.17 | 88.87 |
| 60 | 77.51 | 98.36 | 97.44 | 98.43 | 94.70 | 92.14 |
| 80 | 84.05 | 98.78 | 97.72 | 99.02 | 96.10 | 93.84 |
| 100 | 87.37 | 98.98 | 98.14 | 99.32 | 96.76 | 94.99 |
| 120 | 89.33 | 99.27 | 98.55 | 99.49 | 97.18 | 95.65 |
| 160 | 91.43 | — | 99.07 | — | 98.63 | 98.18 |
| 200 | — | — | 99.53 | — | 99.21 | — |
| | Voltage Efficiency (%) | | | | | |
| 40 | 91.44 | 92.44 | 93.66 | 87.99 | 91.51 | 90.30 |
| 60 | 84.00 | 88.17 | 89.8 | 82.69 | 86.58 | 85.30 |
| 80 | 76.79 | 84.31 | 86.38 | 76.41 | 82.83 | 79.92 |
| 100 | 71.39 | 80.48 | 83.32 | 70.43 | 78.87 | 74.99 |
| 120 | 65.16 | 75.65 | 80.10 | 63.18 | 75.32 | 70.04 |
| 160 | 58.89 | — | 74.24 | — | 67.15 | 66.20 |
| 200 | — | — | 68.04 | — | 61.89 | — |
| | Energy Efficiency (%) | | | | | |
| 40 | 64.48 | 90.46 | 91.00 | 86.25 | 84.87 | 80.25 |
| 60 | 65.11 | 86.73 | 87.50 | 81.39 | 81.99 | 78.60 |
| 80 | 64.54 | 83.28 | 84.41 | 75.67 | 79.60 | 75.00 |
| 100 | 62.38 | 79.66 | 81.77 | 69.95 | 76.32 | 71.23 |
| 120 | 58.21 | 75.10 | 78.94 | 62.86 | 73.19 | 66.99 |
| 160 | 53.85 | — | 73.55 | — | 66.23 | 65.00 |
| 200 | — | — | 67.72 | — | 61.40 | — |

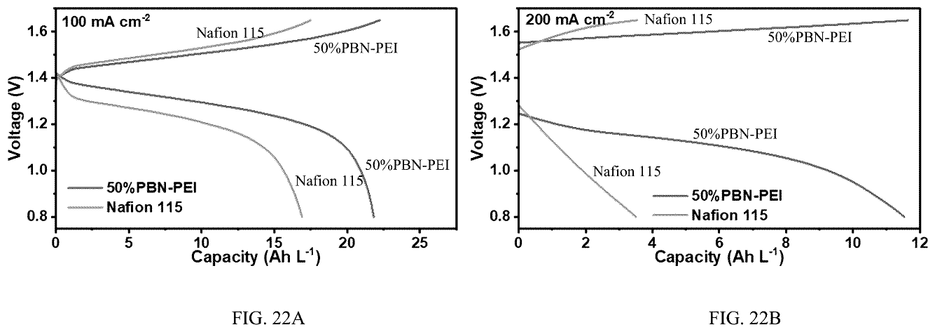

In order to investigate the electrochemical performance of the 50% PBN-PEI membrane, the charge and discharge profiles at different current densities were plotted (FIG. 5E) and compared with the charge and discharge profiles of the pristine PEI and NAFION™ 115 membranes (FIG. 5F). The 50% PBN-PEI membrane exhibited smooth charge and discharge curves at all rates. In comparison with the NAFION™ 115 membrane, the PEI and 50% PBN-PEI membranes had lower overpotentials during the charging process because of their lower area resistances. During the discharge process, the lowest discharge capacity and voltage of the pristine PEI membrane are ascribed to severe self-discharge.^{[25]} It was observed that the 50% PBN-PEI membrane had higher discharge voltage and larger capacity than the NAFION™ 115 membrane, which is more prominent at higher rates (FIG. 22). The impressive performance of the 50% PBN-PEI membrane further confirmed its excellent electrochemical properties.

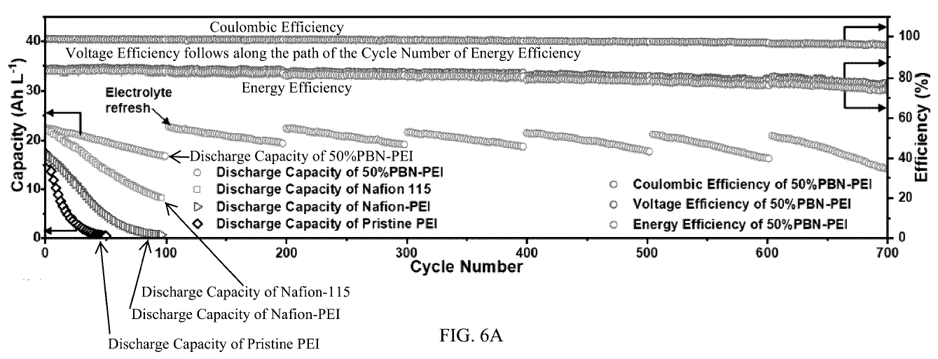

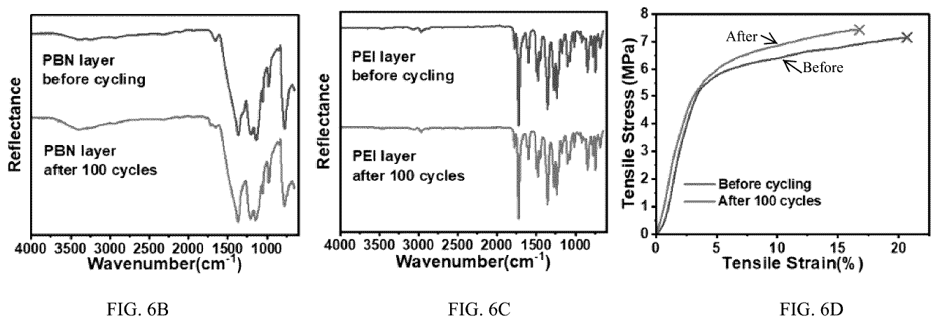

In order to investigate the stability of the 50% PBN-PEI membrane, a battery assembled with the membrane was continuously cycled for over 700 cycles at a current density of 100 mA cm⁻². As shown in FIG. 6A, the capacity gradually decayed during cycling owing to the polarization and the migration of the electrolyte from one side to the other side.^{[26]} Therefore, the electrolyte was refreshed every 100 cycles. After that, the capacity of the battery was fully recovered, and the CE, VE, and EE remained stable. This demonstrates that the 50% PBN-PEI membrane has high electrochemical stability. The average capacity fading rate of the 50% PBN-PEI membrane was 0.17% per cycle, which was significantly lower than those of the pristine PEI (1.95% per cycle), NAFION™-PEI (1.44% per cycle) and NAFION™ 115 (0.74% per cycle) membranes because of the higher ion selectivity and lower vanadium permeability. Meanwhile, the hydrophobicity of the PBN layer prevents the migration of the electrolyte. It is observed that CE, VE, and EE are slightly decreased after 700 cycles. This provides a comprehensive result of the aging of several parts of the battery, including the graphite felts, graphite flow fields, and membranes. FTIR spectroscopy was employed to examine the chemical stability of the 50% PBN-PEI membranes. There are no obvious differences between the PBN and PEI layers before and after 100 cycles (FIG. 6b, c). The mechanical stability was characterized by a tensile test. The 50% PBN-PEI membrane exhibited stable tensile stress after 100 cycles under extreme conditions. Nevertheless, the elongation decreased from 20.68% to 16.33% due to minor deformations during cycling. Overall, the 50% PBN-PEI membrane exhibited excellent stability during long-term cycling.

Conclusion. A highly efficient double-layer ion-selective membrane was obtained by integrating the unique properties of porous boron nitride (PBN) with the advantages of the porous polyetherimide (PEI) membranes and NAFION™ resin. High-nanoporosity PBN flakes were synthesized by a scalable template-free method through dispersion and functionalization by sonication in isopropanol. During sonication, the B—N bonds near the edges or defects in the amorphous part of PBN were attacked by the solvent molecules and broken into new edges with the hydroxyl and amino groups, which increased the hydrophilicity and crystallinity of PBN. The pore size distribution characterization revealed an ultrahigh mesopore volume (0.76 cm³ g⁻¹) of PBN, whereby more than 37% of the pores were smaller than 5 nm, which ensured its high ion selectivity. PBN was further mixed with NAFION™ resin to form a bifunctional ion-selective layer, which combined the nanoporous structure with the ion-exchange groups. Meanwhile, the inorganic rigid PBN structure suppresses the swelling of conventional organic ion-exchange membranes. Through a simple spray-coating process, a PBN ion-selective layer was deposited on a highly ion-conductive and low-cost porous PEI membrane prepared by the NIPS method. The 50% PBN-PEI membrane demonstrated an excellent ion selectivity (1.49×10⁸ mS cm⁻³ min) compared with the pristine PEI membrane (6.71×10⁶ mS cm⁻³ min) while maintaining its high ion conductivity (64 mS cm⁻¹). The 50% PBN-PEI membrane achieved superior performance than the NAFION™ 115 membrane in VRFB with higher CE, VE, EE, and capacity at all current densities and high stability with a lower capacity fading rate (0.17% per cycle vs. 0.74% per cycle) at 100 mA cm⁻². The 50% PBN-PEI membrane also demonstrated a stable operation in VRFB at a current density of 100 mA cm⁻² over 700 cycles. Therefore, the PBN exhibits high ion selectivity based on its nanoporous structure. The introduction of the ion-exchange group to the unique PBN nanoporous structure resulted in excellent ion selectivity and conductivity. The work presented the remarkable performance of the PBN bifunctional layer in terms of ion conductivity and selectivity; the combination with the low-cost high ion-conductive porous PEI membrane demonstrated a great potential for commercialization of the PBN-PEI double-layer membrane.

### Experimental Section/Methods

Materials: Boric acid (H₃BO₃, 99.8%, Alfa Aesar) and urea (Certified ACS, Fisher Chemical) were used to synthesize BN. Polyetherimide (PEI, Sigma-Aldrich), polyvinylpyrrolidone (PVP, MW. 40000, Alfa Aesar), 1-methyl-2-pyrrolidinone (NMP, ≥99%, Sigma-Aldrich) were used for base membrane fabrication. Vanadium (IV) sulfate oxide hydrate (VOSO₄, 99.9%, Alfa Aesar) and sulfuric acid (H₂SO₄, 98.0%, Sigma Aldrich) were used to prepare electrolytes. All chemicals described here were used as received. NAFION™ perfluorinated resin solution (5 wt %, Sigma-Aldrich) diluted to 1 wt % by isopropanol (IPA, 99.5%, Acros) used for binder in the spray process. The graphite felt (GFD 2, 5 EA, Sigracell) was treated at 400° C. for 30 h in the air and cut into 2.3×2.2 cm² used as the electrode. NAFION™ 115 membrane (Ion Power Inc.) was orderly pretreated in 5 wt. % hydrogen peroxide, deionized water, and 1 M sulfuric acid for one hour of each liquid at 80° C. and then stored and stored in 1M sulfuric acid over one day before use.

Fabrication of porous PEI membrane: 22.5 g PEI and 2.5 g PVP were mixed and dissolved in 75 g NMP solvent at 120° C. for 5 hours with magnetic stirring.^{[10d]} The solution was cast on a glass plate at room temperature using the film coater (MSK-AFA-I, MTI) and doctor blade with a thickness of 150 μm. The cast membrane was then immersed in deionized water for 24 h to complete the phase-inversion process and remove the solvent completely.

Synthesis and treatment of PBN: 0.1 mol boric acid and 0.5 mol urea were solved in 100 ml deionized water and dried in the oven overnight at 105° C. The dried intermediate was further ground into powders and placed in the tube furnace (OTF-1200X, MTI) heated to 1050° C. (10° C./min ramp rate) under nitrogen gas flow (0.05 NI/min) and held for 3.5 h.^{[15b]} The furnace was then allowed to cool naturally under a nitrogen atmosphere. Pristine PBN was collected after synthesis. 2 g pristine PBN was further ground into powders and then dispersed into 200 ml IPA by sonicating for 4 hours. The dispersion was centrifuged for 10 min at 2500 rpm by Sorvall T1 Centrifuge (Thermo Scientific). The PBN in the suspension was further collected by the PTFE filter through vacuum filtration.

Preparation of PBN-PEI membrane: Different amounts of PBN (e.g., 9.0 mg) were dispersed in 4 ml IPA by sonicating for 1 hour and then mixed with different amounts (e.g., 90 mg) of 1wt % NAFION™ perfluorinated resin solution by sonicating an additional 10 min to form a uniform suspension. The suspensions were uniformly sprayed on the top surface (waterside in the casting process) of the PEI membrane by airbrush until the surface became wet, and then the membrane was heated on the hotplate (Cimarec+™, Thermo Scientific) at 60° C. until the surface became dried. These two processes were repeated until all suspensions were sprayed. All membranes were further treated in deionized water and 1M sulfuric at 80° C. for one hour for each liquid and stored in IM sulfuric acid over one night before use.

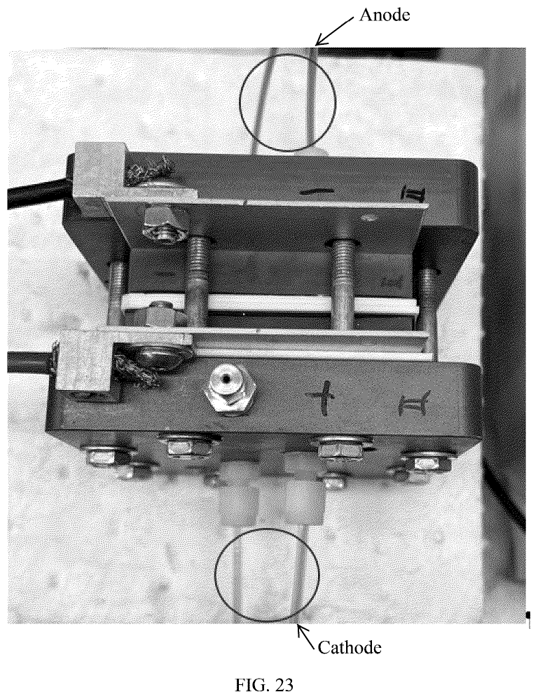

Single flow battery performance: The flow battery was assembled by sandwiching a membrane between four graphite felts, two on each side, clamped by two pieces of graphite flow fields and gold-coating current collectors. In this case, the coated layer of the double-layer membrane was placed on the anode side. The effective area of the electrode and membrane was 5 cm². The 1M VOSO₄ and 3M H₂SO₄ solution was charged to V^{3.5+} electrolyte for both the cathode and anode sides. The cell was firstly fully charged the battery at a constant voltage of 1.65 V until the current dropped below 10 mA (FIG. 23) and discharged at a constant current of 200 mA to 0.8V to complete the initialization. The cycling and rate performance was carried out by the battery test system (CT2001A, LAND, China).

The characterizations and membrane properties measurements methods are shown in the Supporting Information, including SEM, XCT, PSD, XRD, FTIR, TGA, contact angle measurement, water uptake, and swelling measurements, area resistance and ion conductivity measurements, vanadium (IV) permeability and ion selectivity measurements, and tensile strength measurement.

Supporting Information. Characterization methods used in the Example follow.

Scanning electronic microscopy (SEM): The morphologies of porous BN and membranes were observed using a scanning electron microscope (S4800, Hitachi). The cross-section of the membrane was observed by breaking the membranes in liquid nitrogen. All samples were platinum-coated before observation.

X-ray computed tomography (XCT): The X-ray computed tomography of the porous PEI membrane was conducted on FXI beamline at National Synchrotron Light Source II of Brookhaven National Laboratory. Dragonfly software was used to reconstruct the three-dimensional structure.

Pore size distribution analysis: The nitrogen physisorption isotherms of PBN were measured at 77 K by an accelerated surface area and porosimetry system (ASAP™ 2020, micropolitics). Before the test, all samples were degassed in a vacuum for 12 hours. Pore size distribution was calculated by the non-local density functional theory (NLDFT) method by the QuadraWin software.

X-Ray Diffraction (XRD)): The XRD spectra were collected by PANalytical/Philips X'Pert Pro (PANalytical, Netherlands) with Cu Kα radiation. All samples were ground into powers before the test. The full-width half maximum and crystallinity were calculated by MDI Jade software.

Fourier transformed infrared (FTIR) spectroscopy: The FTIR spectra were recorded by Cary 630 FTIR (Agilent) under the reflectance mode ranging from 4000 cm⁻¹ to 750 cm⁻¹. All samples were ground into powers before the test.

Thermogravimetric analysis (TGA): The TGA of PBN was performed in TA Q50 Thermogravimetric analyzer (TA Instruments) from room temperature to 1000° C. under the nitrogen atmospheres.

Contact angle measurements: The contact angle was investigated by the optical contact angle measuring instrument (SDC-350, SINDIN). The PBN powders were compressed into tablet formats by applying 60 Mpa pressure 10 min in a cylindrical mold with a diameter of 12.6 mm. For the membranes, before the measurement, all membranes were dried at 80° C. for 24 hours to remove water and taped on a glass substrate. The frozen images were taken after dropping 8 μL of deionized water on the membrane surface for 5 seconds.

Water uptake and swelling measurements: The membrane after the pretreatment was immersed in the deionized water over 24 hours to remove the acid and was wiped to remove the water on the surface. The weight and length of the wet membrane were measured and recorded as W_{wet} and L_{wet}. The membrane was further dried at 80° C. for 24 h to remove the water from the membrane. The weight and length of the dried membrane were measured and recorded as W_{dry} and L_{dry}. The water uptake was calculated by Equation S1:

$$Water uptake = \frac{( {W}_{wet} - {W}_{dry} )}{{W}_{dry}} \times 100 \% \qquad ( S1 )$$

The swelling ratio was calculated by Equation S2:

$$Swelling ratio = \frac{( {L}_{wet} - {L}_{dry} )}{{L}_{dry}} \times 100 \% \qquad ( S2 )$$

Area resistance and ion conductivity measurements: The area resistances of embranes were measured in the flow cell by the electrochemical impedance spectroscopy (EIS) (SP-150, BioLogic) with an effective area of 5 cm² and 1 M VOSO₄ and 3M H₂SO₄ as electrolytes. The sinusoidal voltage waveform of amplitude was 10 mV, and the frequency range was from 500 kHz to 100 Hz. The area resistances (R) were calculated by Equation S3, where Rₛ and R₀ are the high-frequency intercepts with the horizontal axis (X) with and without the membrane, and A is the effective area.

R=(Rₛ−R₀)×A (S3)

Ion conductivities (c) were calculated by Equation 4, where L is the membrane thickness.

$$σ = \frac{L}{R} = \frac{L}{( {R}_{s} - {R}_{o} ) \times A} \qquad ( S4 )$$

Vanadium (IV) permeability and ion selectivity measurements: A H-cell separated by different membranes was used to evaluate the vanadium permeability. The left-side chamber was filled with 10 mL 1 M VOSO₄ in a 3 M H₂SO₄ solution, and the right-side chamber was filled with 10 mL 1 M MgSO₄+3 M H₂SO₄ solution. 1 mL of solution was collected from the right-side chamber every 2 hours, and the chamber was replenished by fresh 1 M MgSO₄+3 M H₂SO₄ solution to maintain the same volume at each side. To detect the vanadium permeability, the absorbance of each sample was measured at 760 nm wavelength using a UV-vis spectrometer (Agilent 8453, USA), and a calibration curve of VOSO₄ was also obtained at 760 nm wavelength. The vanadium permeability rate was then calculated from the concentration equivalent to each measured absorbance using the calibration curve. The permeabilities (P) were calculated by Equation S5 (a pseudo-steady-state order was applied in between the membrane), where L is the membrane thickness, A is the effective area, V_{R} is the volume of the right chamber, C_{L} is the VO²⁺ concentration in the left chamber (assuming the change of the concentration was negligible during the test), C_{R}(t) is the VO²⁺ concentration on the right chamber as a function of time, and t is time.

$$P = \frac{{LV}_{R}}{{AC}_{L}} \frac{{dC}_{R} ( t )}{dt} \qquad ( S5 )$$

The ion selectivity (S) was calculated by Equation S6, where P was permeability and σ is ion conductivity.

$$S = \frac{σ}{P} \qquad ( S6 )$$

Tensile strength: The tensile strength of the wet membrane was measured by a rotational rheometer (ARES-G2, TA Instruments) with a 100 μm min⁻¹ displacement speed. The sample was cut into the size of 20 mm in length and 5 mm in width and stored in deionized water until the measurement.

### REFERENCES

[1] a) Y. Yao, J. Lei, Y. Shi, F. Ai, Y.-C. Lu, Nature Energy 2021, 6, 582: b) B. Dunn, H. Kamath, J.-M. J. S. Tarascon, 2011, 334, 928.
[2] P. Leung, X. Li, C. P. De León, L. Berlouis, C. J. Low, F. C. J. R. A. Walsh, 2012, 2, 10125.
[3] A. Mukhopadhyay, Y. Yang, Z. Cheng, P. Luan, A. Natan, H. Zhu, Materials Today Nano 2021, 13, 100100.
[4] J. Sheng, A. Mukhopadhyay, W. Wang, H. Zhu, Materials Today Nano 2019, 7, 100044.
[5] a) T. Luo, S. Abdu, M. Wessling, Journal of membrane science 2018, 555, 429; b) L. Liu, C. Wang, Z. He, R. Das, B. Dong, X. Xie, Z. Guo, Journal of Materials Science Technology 2021, 69, 212. D. W. Shin, M. D. Guiver, Y. M. Lee, Chemical reviews 2017, 117, 4759.
[6] D. W. Shin, M. D. Guiver, Y. M. Lee, Chemical reviews 2017, 117, 4759.
[7] Z. Yuan, H. Zhang, X. Li, Chemical Communications 2018, 54, 7570.
[8] J. Liu, L. Yu, X. Cai, U. Khan, Z. Cai, J. Xi, B. Liu, F. Kang, ACS nano 2019, 13, 2094.
[9] W. Chen, B. Pang, X. Yan, X. Jiang, F. Cui, X. Wu, G. He, Journal of Membrane Science 2022, 644, 120084.
[10] a) L. Qiao, H. Zhang, W. Lu, Q. Dai, X. Li, ACS applied materials & interfaces 2019, 11, 24107; b) D. Chen, D. Li, X. Li, Journal of Power Sources 2017, 353, 11: c) Q. Dai, Z. Liu, L. Huang, C. Wang, Y. Zhao, Q. Fu, A. Zheng, H. Zhang, X. Li, Nature communications 2020, 11, 1: d) Y. Zhao, P. Xiang, Y. Wang, X. Sun, D. Cao, H. Zhu, Journal of Membrane Science 2021, 640, 119804.
[11] L. Wan, C. Liu, D. Cao, X. Sun, H. Zhu, ACS Applied Polymer Materials 2020, 2, 3001.
[12] a) X.-F. Jiang, Q. Weng, X.-B. Wang, X. Li, J. Zhang, D. Golberg, Y. Bando, Journal of Materials Science & Technology 2015, 31, 589: b) W. Lei, D. Portehault, D. Liu, S. Qin, Y. Chen, Nature communications 2013, 4, 1: c) P. Singla, N. Goel, S. Singhal, Ceramics International 2015, 41, 10565.
[13] a) X. Wang, C. Zhi, L. Li, H. Zeng, C. Li, M. Mitome, D. Golberg, Y. Bando, Advanced Materials 2011, 23, 4072: b) S. Büchele, Z. Chen, E. Fako, F. Krumeich, R. Hauert, O. V. Safonova, N. López, S. Mitchell, J. Pérez-Ramírez, Angewandte Chemie 2020, 132, 19807.
[14] a) S. Schlienger, J. Alauzun, F. Michaux, L. Vidal, J. Parmentier, C. Gervais, F. Babonneau, S. Bernard, P. Miele, J. Parra, Chemistry of Materials 2012, 24, 88: b) P. Dibandjo, L. Bois, F. Chassagneux, D. Cornu, J. M. Letoffe, B. Toury, F. Babonneau, P. Miele, Advanced Materials 2005, 17, 571.
[15] a) S. Marchesini, A. Regoutz, D. Payne, C. Petit, Microporous Mesoporous Materials 2017, 243, 154: b) S. Marchesini, C. M. McGilvery, J. Bailey, C. Petit, ACS nano 2017, 11, 10003: c) A. Nag, K. Raidongia, K. P. Hembram, R. Datta, U. V. Waghmare, C. Rao, ACS nano 2010, 4, 1539: d) J. Li, J. Lin, X. Xu, X. Zhang, Y. Xue, J. Mi, Z. Mo, Y. Fan, L. Hu, X. Yang, Nanotechnology 2013, 24, 155603: e) R. Shankar, S. Marchesini, C. Petit, The Journal of Physical Chemistry C 2019, 123, 4282: f) A. L'Hermitte, D. M. Dawson, P. Ferrer, K. Roy, G. Held, T. Tian, S. E. Ashbrook, C. Petit, The Journal of Physical Chemistry C 2021, 125, 27429.
[16] a) A. Hayat, M. Sohail, M. S. Hamdy, T. Taha, H. S. AlSalem, A. M. Alenad, M. A. Amin, R. Shah, A. Palamanit, J. Khan, Surfaces Interfaces 2022, 101725; b) J. H. Ramirez Leyva, G. Vitale, A. Hethnawi, A. Hassan, M. J. Perez-Zurita, G. U. Ruiz-Esparza, N. N. Nassar, ACS Applied Nano Materials 2018, 1, 4491.
[17] A. Mukhopadhyay, Z. Cheng, A. Natan, Y. Ma, Y. Yang, D. Cao, W. Wang, H. Zhu, Nano Letters 2019, 19, 8979.
[18] a) B. Zou, X. Chang, J. Yang, S. Wang, J. Xu, S. Wang, S. Samukawa, L. Wang, Progress in Organic Coatings 2019, 133, 139; b) K. Yu, J. Kim, C. Lee, A.-R. Jang, H. S. Shin, K. S. Kim, Y.-J. Yu, E. Choi, Applied Physics Letters 2016, 108, 241910.
[19] I. M. Joni, R. Balgis, T. Ogi, T. Iwaki, K. Okuyama, Colloids Surfaces A: Physicochemical Engineering Aspects 2011, 388, 49.
[20] a) Y. Lin, T. V. Williams, T.-B. Xu, W. Cao, H. E. Elsayed-Ali, J. W. J. T. J. o. P. C. C. Connell, 2011, 115, 2679; b) Q. Weng, X. Wang, X. Wang, Y. Bando, D. Golberg, Chemical Society Reviews 2016, 45, 3989.
[21] A. Alghunaim, S. Kirdponpattara, B.-m. Z. Newby, Powder Technology 2016, 287, 201.
[22] M. Thommes, K. Kaneko, A. V. Neimark, J. P. Olivier, F. Rodriguez-Reinoso, J. Rouquerol, K. S. Sing, Pure applied chemistry 2015, 87, 1051.
[23] B. Jiang, L. Yu, L. Wu, D. Mu, L. Liu, J. Xi, X. Qiu, ACS applied materials interfaces 2016, 8, 12228.
[24] T. Wang, S. J. Moon, D.-S. Hwang, H. Park, J. Lee, S. Kim, Y. M. Lee, S. Kim, Journal of Membrane Science 2019, 583, 16.
[25] D. Chen, M. A. Hickner, E. Agar, E. C. Kumbur, Journal of membrane science 2013, 437, 108.
[26] a) Y. Song, X. Li, J. Xiong, L. Yang, G. Pan, C. Yan, A. Tang, Journal of Power Sources 2020, 449, 227503; b) Q. Luo, L. Li, W. Wang, Z. Nie, X. Wei, B. Li, B. Chen, Z. Yang, V. Sprenkle, ChemSusChem 2013, 6, 268.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments.

What is claimed is:

1. A double-layer ion-selective membrane, comprising:
a polyetherimide (PEI) layer having longitudinal unimpeded finger-like pores, and
an ultrathin layer comprising porous boron nitride (PBN) flakes defining a tortuous path and enmeshed by a perfluorinated sulfonic acid ionomer resin that forms proton transfer channels created by the sulfonic acid groups of the perfluorinated sulfonic acid ionomer resin, the ultrathin layer coated on an open pore end of the PEI layer.

2. The membrane of claim 1, wherein the PBN flakes are crystalline PBN flakes.

3. The membrane of claim 1, wherein the ultrathin PBN layer is from about 2 μm to about 8 μm thick.

4. The membrane of claim 1, wherein the PEI layer thickness is about 95 μm to about 120 μm.

5. The membrane of claim 1, wherein the PBN flakes and perfluorinated sulfonic acid ionomer resins are present in a ratio of about 1:1 weight percent, about 1:2 weight percent, about 1:3 weight percent, about 3:1 weight percent, or about 2:1 weight percent.

6. The membrane of claim 1, wherein the PBN layer comprises about 50% perfluorinated sulfonic acid ionomer resin by weight.

7. A method for producing a double-layer ion-selective membrane, the method comprising:
dispersing flakes of porous boron nitrate (PBN) and perfluorinated sulfonic acid ionomer resin together in a solvent to produce a sprayable suspension of PBN flakes and the perfluorinated sulfonic acid ionomer resin; and
spray coating the suspension of PBN flakes and the perfluorinated sulfonic acid ionomer resin in an amount sufficient to coat an ultrathin layer on an open pore side of a polyetherimide (PEI) membrane having longitudinal unimpeded finger-like pores, to produce a double-layer ion-selective membrane;
wherein the double-layer ion-selective membrane comprises:
a polyetherimide (PEI) layer having longitudinal unimpeded finger-like pores, and
an ultrathin layer comprising porous boron nitride (PBN) flakes defining a tortuous path and enmeshed by a perfluorinated sulfonic acid ionomer resin that forms proton transfer channels created by the sulfonic acid groups of the perfluorinated sulfonic acid ionomers, the ultrathin layer coated on an open pore end of the PEI layer.

8. The method of claim 7, wherein the polyetherimide (PEI) membrane is prepared through a non-solvent induced phase separation (NIPS) method.

9. The method of claim 8, wherein the NIPS method is performed by mixing PEI and polyvinylpyrrolidone (PVP) dissolved in N-methyl-2-pyrrolidone.

10. The method of claim 7, wherein the PBN flakes are produced by combining boric acid and urea in water while being heated, drying and grinding into a powder.

11. The method of claim 10, further comprising crystallizing the PBN flakes.

12. The method of claim 7, wherein the PBN flakes and the perfluorinated sulfonic acid ionomer resins are present in a ratio of about 1:1 weight percent, about 1:2 weight percent, about 1:3 weight percent, about 3:1 weight percent, or about 2:1 weight percent.

13. The method of claim 7, wherein the PBN layer comprises about 50% perfluorinated sulfonic acid ionomer resin by weight.

14. The method of claim 7, wherein the suspension is sprayed uniformly onto an open pore surface of the PEI membrane.

15. A redox flow battery comprising the membrane of claim 1.

16. The redox flow battery of claim 15, wherein the membrane has a Coulombic efficiency of at least about 90%, an energy efficiency of at least about 85% at 40 mA cm⁻², and a stable cycling performance for over about 700 cycles at 100 mA cm⁻².

17. The redox flow battery of claim 16, wherein the redox flow battery is a vanadium redox flow battery.

18. A fuel cell battery comprising the membrane of claim 1.

19. A wastewater purification system comprising the membrane of claim 1, wherein the membrane separates water from an aqueous solution through forward osmosis to recover purified water.

20. An air purification system comprising the membrane of claim 1, wherein the membrane separates polluted air by trapping impurities in the membrane pores and releasing purified air.
